(19) United States
(12) Patent Application Publication
(10) Pub. No.: US 2023/0118475 A1
(43) Pub. Date: Apr. 20, 2023

(54) VIRTUAL RESOURCE BLOCK TO PHYSICAL RESOURCE BLOCK MAPPING IN DUPLEX SLOTS

(71) Applicant: QUALCOMM Incorporated, San Diego, CA (US)

(72) Inventors: Ahmed Attia ABOTABL, San Diego, CA (US); Seyedkianoush HOSSEINI, San Diego, CA (US); Muhammad Sayed Khairy ABDELGHAFFAR, San Jose, CA (US); Alexandros MANOLAKOS, Escondido, CA (US); Gabi SARKIS, San Diego, CA (US); Yi HUANG, San Diego, CA (US); Krishna Kiran MUKKAVILLI, San Diego, CA (US)

(21) Appl. No.: 17/906,057

(22) PCT Filed: Apr. 23, 2021
(86) PCT No.: PCT/CN2021/089242

§ 371 Date: Sep. 9, 2022

(30) Foreign Application Priority Data
May 12, 2020 (GR) 2020/0100246

(51) Int. Cl. H04W 72/1263; H04W 72/23; H04L 5/14

(52) U.S. Cl. CPC H04W 72/1263; H04W 72/23; H04L 5/14

(57) ABSTRACT

Methods, systems, and devices for wireless communications are described that support virtual resource block (RB) to physical RB mapping in duplex slots. The described techniques enable a user equipment (UE) to select an interleaving configuration such as a full duplex or half duplex interleaving configuration for a slot that may be configured for full duplex communications. In some cases, the UE may use a default interleaving configuration for a given slot or may determine the interleaving configuration based on a bandwidth part (BWP) position or resource bandwidth within the slot, such as a location within the frequency domain of a downlink BWP relative to an uplink BWP.

### CROSS REFERENCE

The present Application is a 371 national stage filing of International PCT Application No. PCT/CN2021/089242 by ABOTABL et al. entitled “VIRTUAL RESOURCE BLOCK TO PHYSICAL RESOURCE BLOCK MAPPING IN DUPLEX SLOTS,” filed Apr. 23, 2021; and claims priority to Greece Provisional Patent Application No. 2020/0100246 by ABOTABL et al., entitled “VIRTUAL RESOURCE BLOCK TO PHYSICAL RESOURCE BLOCK MAPPING IN DUPLEX SLOTS,” filed May 12, 2020, each of which is assigned to the assignee hereof, and each of which is expressly incorporated by reference in its entirety herein.

### FIELD OF TECHNOLOGY

The following relates generally to wireless communications and more specifically to virtual resource block (RB) to physical RB mapping in duplex slots.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support virtual resource block (RB) to physical RB mapping in duplex slots. Generally, the described techniques enable a user equipment (UE) to select an interleaving configuration for a slot configured for full duplex communications based on one or more conditions. The UE may communicate with a base station according to the interleaving configuration. In some cases, the UE may assume a default interleaving configuration or may determine the interleaving configuration based on a bandwidth part (BWP) position or resource bandwidth in the slot. Additionally, or alternatively, the UE may receive, from the base station, an indication of the interleaving configuration.

A method of wireless communication at a UE is described. The method may include receiving, from a base station, scheduling information for an uplink transmission and a downlink transmission, determining that a slot is configured for full duplex communications with the base station based on the scheduling information, selecting an interleaving configuration for the full duplex communications in the slot based on the scheduling information and determining that the slot is configured for full duplex communications, and communicating with the base station in the slot based on the interleaving configuration.

An apparatus for wireless communication at a UE is described. The apparatus may include a processor, memory coupled with the processor, and instructions stored in the memory. The instructions may be executable by the processor to cause the apparatus to receive, from a base station, scheduling information for an uplink transmission and a downlink transmission, determine that a slot is configured for full duplex communications with the base station based on the scheduling information, select an interleaving configuration for the full duplex communications in the slot based on the scheduling information and determining that the slot is configured for full duplex communications, and communicate with the base station in the slot based on the interleaving configuration.

Another apparatus for wireless communication at a UE is described. The apparatus may include means for receiving, from a base station, scheduling information for an uplink transmission and a downlink transmission, determining that a slot is configured for full duplex communications with the base station based on the scheduling information, selecting an interleaving configuration for the full duplex communications in the slot based on the scheduling information and determining that the slot is configured for full duplex communications, and communicating with the base station in the slot based on the interleaving configuration.

A non-transitory computer-readable medium storing code for wireless communication at a UE is described. The code may include instructions executable by a processor to receive, from a base station, scheduling information for an uplink transmission and a downlink transmission, determine that a slot is configured for full duplex communications with the base station based on the scheduling information, select an interleaving configuration for the full duplex communications in the slot based on the scheduling information and determining that the slot is configured for full duplex communications, and communicate with the base station in the slot based on the interleaving configuration.

Some examples of the method, apparatuses, and non-transitory computer-readable medium described herein may further include operations, features, means, or instructions for determining a downlink BWP and a downlink resource bandwidth for the downlink transmission based on the scheduling information, where the interleaving configuration may be selected based on the downlink BWP and the downlink resource bandwidth.

In some examples of the method, apparatuses, and non-transitory computer-readable medium described herein, selecting the interleaving configuration may include operations, features, means, or instructions for selecting the interleaving configuration based on a location of the downlink BWP and the downlink resource bandwidth within a set of bands configured for downlink communications.

In some examples of the method, apparatuses, and non-transitory computer-readable medium described herein, selecting the interleaving configuration may include operations, features, means, or instructions for determining an uplink BWP and an uplink resource bandwidth for the uplink transmission based on the scheduling information, and selecting the interleaving configuration based on a location of the downlink BWP relative to the uplink BWP in a frequency domain or a location of the downlink resource bandwidth relative to the uplink resource bandwidth in the frequency domain.

In some examples of the method, apparatuses, and non-transitory computer-readable medium described herein, selecting the interleaving configuration may include operations, features, means, or instructions for selecting a half duplex interleaving configuration based at least in part on the downlink BWP being located a threshold distance in a frequency domain apart from an uplink BWP for the uplink transmission or the downlink resource bandwidth being located the threshold distance in the frequency domain apart from an uplink resource bandwidth for the uplink transmission.

In some examples of the method, apparatuses, and non-transitory computer-readable medium described herein, selecting the interleaving configuration may include operations, features, means, or instructions for selecting a full duplex interleaving configuration based at least in part on the downlink BWP being located within a threshold distance in a frequency domain from an uplink BWP for the uplink transmission or the downlink resource bandwidth being located within the threshold distance in the frequency domain from an uplink resource bandwidth for the uplink transmission.

Some examples of the method, apparatuses, and non-transitory computer-readable medium described herein may further include operations, features, means, or instructions for determining multiple downlink BWPs for the downlink transmission based on the scheduling information, and selecting the interleaving configuration based on respective locations of the multiple downlink BWPs within a set of bands configured for downlink communications.

In some examples of the method, apparatuses, and non-transitory computer-readable medium described herein, selecting the interleaving configuration may include operations, features, means, or instructions for selecting a full duplex interleaving configuration based on the respective locations being positioned on both sides of an uplink BWP for the uplink transmission in a frequency domain.

In some examples of the method, apparatuses, and non-transitory computer-readable medium described herein, selecting the interleaving configuration may include operations, features, means, or instructions for selecting a full duplex interleaving configuration based on determining that the slot may be configured for full duplex communications.

In some examples of the method, apparatuses, and non-transitory computer-readable medium described herein, receiving the scheduling information may include operations, features, means, or instructions for receiving an indication of the interleaving configuration, where selecting the interleaving configuration may be based on the indication.

In some examples of the method, apparatuses, and non-transitory computer-readable medium described herein, the indication may be a one bit indicator within downlink control information.

Some examples of the method, apparatuses, and non-transitory computer-readable medium described herein may further include operations, features, means, or instructions for determining that a set of repetitions of the downlink transmission spans multiple slots including the slot based on the scheduling information, where the interleaving configuration may be selected based on the set of repetitions.

In some examples of the method, apparatuses, and non-transitory computer-readable medium described herein, selecting the interleaving configuration may include operations, features, means, or instructions for selecting a half duplex interleaving configuration for each slot of the multiple slots configured for half duplex communications, and selecting a full duplex interleaving configuration for each slot of the multiple slots configured for full duplex communications.

Some examples of the method, apparatuses, and non-transitory computer-readable medium described herein may further include operations, features, means, or instructions for determining a downlink BWP and a downlink resource bandwidth for a repetition of the set of repetitions in a full duplex slot of the multiple slots, and selecting a half duplex interleaving configuration for the full duplex slot based on the downlink BWP being located a threshold distance in a frequency domain apart from an uplink BWP for the uplink transmission or the resource bandwidth being located the threshold distance in the frequency domain apart from an uplink resource bandwidth for the uplink transmission.

Some examples of the method, apparatuses, and non-transitory computer-readable medium described herein may further include operations, features, means, or instructions for receiving a message indicating the half duplex interleaving configuration from the base station, where the half duplex interleaving configuration may be selected based on the message.

Some examples of the method, apparatuses, and non-transitory computer-readable medium described herein may further include operations, features, means, or instructions for determining multiple downlink BWPs for a repetition of the set of repetitions in a full duplex slot of the multiple slots, and selecting a full duplex interleaving configuration for the full duplex slot based on the multiple downlink BWPs being positioned on both sides of an uplink BWP for the uplink transmission in a frequency domain within the full duplex slot.

A method of wireless communications at a base station is described. The method may include determining that a slot is configured for full duplex communications with a UE based on an uplink transmission and a downlink transmission for the UE, selecting an interleaving configuration for the full duplex communications in the slot based on determining that the slot is configured for full duplex communications, and communicating the uplink transmission and the downlink transmission with the UE based on the interleaving configuration.

An apparatus for wireless communications at a base station is described. The apparatus may include a processor, memory coupled with the processor, and instructions stored in the memory. The instructions may be executable by the processor to cause the apparatus to determine that a slot is configured for full duplex communications with a UE based on an uplink transmission and a downlink transmission for the UE, select an interleaving configuration for the full duplex communications in the slot based on determining that the slot is configured for full duplex communications, and communicate the uplink transmission and the downlink transmission with the UE based on the interleaving configuration.

Another apparatus for wireless communications at a base station is described. The apparatus may include means for determining that a slot is configured for full duplex communications with a UE based on an uplink transmission and a downlink transmission for the UE, selecting an interleaving configuration for the full duplex communications in the slot based on determining that the slot is configured for full duplex communications, and communicating the uplink transmission and the downlink transmission with the UE based on the interleaving configuration.

A non-transitory computer-readable medium storing code for wireless communications at a base station is described. The code may include instructions executable by a processor to determine that a slot is configured for full duplex communications with a UE based on an uplink transmission and a downlink transmission for the UE, select an interleaving configuration for the full duplex communications in the slot based on determining that the slot is configured for full duplex communications, and communicate the uplink transmission and the downlink transmission with the UE based on the interleaving configuration.

Some examples of the method, apparatuses, and non-transitory computer-readable medium described herein may further include operations, features, means, or instructions for determining a downlink BWP and a downlink resource bandwidth for the downlink transmission, where the interleaving configuration may be selected based on the downlink BWP and the downlink resource bandwidth.

In some examples of the method, apparatuses, and non-transitory computer-readable medium described herein, selecting the interleaving configuration may include operations, features, means, or instructions for selecting the interleaving configuration based on a location of the downlink BWP or the downlink resource bandwidth within a set of bands configured for downlink communications.

In some examples of the method, apparatuses, and non-transitory computer-readable medium described herein, selecting the interleaving configuration may include operations, features, means, or instructions for determining an uplink BWP and an uplink resource bandwidth for the uplink transmission, and selecting the interleaving configuration based on a location of the downlink BWP relative to the uplink BWP in a frequency domain or a location of the downlink resource bandwidth relative to the uplink resource bandwidth in the frequency domain.

In some examples of the method, apparatuses, and non-transitory computer-readable medium described herein, selecting the interleaving configuration may include operations, features, means, or instructions for selecting a half duplex interleaving configuration based at least in part on the downlink BWP being located a threshold distance in a frequency domain apart from an uplink BWP for the uplink transmission or the downlink resource bandwidth being located the threshold distance in the frequency domain apart from an uplink resource bandwidth for the uplink transmission.

Some examples of the method, apparatuses, and non-transitory computer-readable medium described herein may further include operations, features, means, or instructions for determining multiple downlink BWPs for the downlink transmission, and selecting the interleaving configuration based on respective locations of the multiple downlink BWPs within a set of bands configured for downlink communications.

In some examples of the method, apparatuses, and non-transitory computer-readable medium described herein, selecting the interleaving configuration may include operations, features, means, or instructions for selecting a full duplex interleaving configuration based on the respective locations being positioned on both sides of an uplink BWP for the uplink transmission in a frequency domain.

Some examples of the method, apparatuses, and non-transitory computer-readable medium described herein may further include operations, features, means, or instructions for selecting a full duplex interleaving configuration based on determining that the slot may be configured for full duplex communications.

Some examples of the method, apparatuses, and non-transitory computer-readable medium described herein may further include operations, features, means, or instructions for transmitting, to the UE, scheduling information for the uplink transmission and the downlink transmission, where the scheduling information indicates the interleaving configuration.

In some examples of the method, apparatuses, and non-transitory computer-readable medium described herein, the scheduling information includes a one bit indicator within downlink control information that indicates the interleaving configuration.

Some examples of the method, apparatuses, and non-transitory computer-readable medium described herein may further include operations, features, means, or instructions for determining that a set of repetitions of the downlink transmission spans multiple slots including the slot, where the interleaving configuration may be selected based on the set of repetitions.

In some examples of the method, apparatuses, and non-transitory computer-readable medium described herein, selecting the interleaving configuration may include operations, features, means, or instructions for selecting a half duplex interleaving configuration for each slot of the multiple slots configured for half duplex communications, and selecting a full duplex interleaving configuration for each slot of the multiple slots configured for full duplex communications.

Some examples of the method, apparatuses, and non-transitory computer-readable medium described herein may further include operations, features, means, or instructions for determining a downlink BWP and a downlink resource bandwidth for a repetition of the set of repetitions in a full duplex slot of the multiple slots, and selecting a half duplex interleaving configuration for the full duplex slot based on the downlink BWP being located a threshold distance in a frequency domain apart from an uplink BWP for the uplink transmission or the downlink resource bandwidth being located the threshold distance in the frequency domain apart from an uplink resource bandwidth for the uplink transmission.

Some examples of the method, apparatuses, and non-transitory computer-readable medium described herein may further include operations, features, means, or instructions for receiving a message indicating the half duplex interleaving configuration to the UE, where the message includes a downlink control message or a radio resource control message.

Some examples of the method, apparatuses, and non-transitory computer-readable medium described herein may further include operations, features, means, or instructions for determining multiple downlink BWPs for a repetition of the set of repetitions in a full duplex slot of the multiple slots, and selecting a full duplex interleaving configuration for the full duplex slot based on the multiple downlink BWPs being positioned on both sides of an uplink BWP for the uplink transmission in a frequency domain within the full duplex slot.

### BRIEF DESCRIPTION OF THE DRAWINGS

FIG. 1 illustrates an example of a wireless communications system that supports virtual resource block (RB) to physical RB mapping in duplex slots in accordance with aspects of the present disclosure.

FIG. 2 illustrates an example of a wireless communications system that supports virtual RB to physical RB mapping in duplex slots in accordance with aspects of the present disclosure.

FIG. 3 illustrates an example of a resource structure that supports virtual RB to physical RB mapping in duplex slots in accordance with aspects of the present disclosure.

FIG. 4 illustrates an example of a process flow that supports virtual RB to physical RB mapping in duplex slots in accordance with aspects of the present disclosure.

FIGS. 5 and 6 show block diagrams of devices that support virtual RB to physical RB mapping in duplex slots in accordance with aspects of the present disclosure.

FIG. 7 shows a block diagram of a communications manager that supports virtual RB to physical RB mapping in duplex slots in accordance with aspects of the present disclosure.

FIG. 8 shows a diagram of a system including a device that supports virtual RB to physical RB mapping in duplex slots in accordance with aspects of the present disclosure.

FIGS. 9 and 10 show block diagrams of devices that support virtual RB to physical RB mapping in duplex slots in accordance with aspects of the present disclosure.

FIG. 11 shows a block diagram of a communications manager that supports virtual RB to physical RB mapping in duplex slots in accordance with aspects of the present disclosure.

FIG. 12 shows a diagram of a system including a device that supports virtual RB to physical RB mapping in duplex slots in accordance with aspects of the present disclosure.

FIGS. 13 through 21 show flowcharts illustrating methods that support virtual RB to physical RB mapping in duplex slots in accordance with aspects of the present disclosure.

### DETAILED DESCRIPTION

A base station may communicate with a user equipment (UE) using full duplex slots (e.g., both uplink and downlink communications performed within the slot) or half duplex slots (e.g., only uplink or only downlink communications performed within the slot). The base station may use an interleaving configuration to map virtual resource blocks (RBs) to physical RBs in the slots, and the configurations may differ between full duplex slots and half duplex slots. However, in some cases, the base station may utilize a half duplex interleaving configuration in a full duplex slot, and the UE may be unaware of the change in interleaving. Further, some transmissions from the base station may span multiple types of slots, and the base station may use a combination of interleaving configurations over the span of slots. In such cases, the UE may be not properly decode a transmission in the one or more slots, which may result in lost communications and, in some examples, decreased network efficiency.

The techniques described herein may enable a UE to select an interleaving configuration for a slot based on the type of slot, a bandwidth part (BWP) position or resource bandwidth in the slot, or an indication received from a base station. For example, the UE may determine that a half duplex interleaving configuration is used for half duplex slots and a full duplex interleaving configuration is used for full duplex slots. Alternatively, the base station may include an indication of the configuration in a transmission (e.g., downlink control information (DCI)) to the UE. In some cases, the selection of the configuration may depend on the uplink and downlink BWPs scheduled for respective uplink and downlink transmissions within a full duplex slot. That is, the UE may select an interleaver to be used in the full duplex slot according to the location of the downlink BWP relative to the uplink BWP. For instance, if the downlink BWP is located close (e.g., in frequency) to the uplink BWP, the UE may experience self-interference, which may be mitigated by selecting a full duplex interleaving configuration for the slot. Alternatively, if the downlink BWP is located far enough (e.g., in frequency) from the uplink BWP, the UE may use a half duplex interleaving configuration without experiencing additional interference.

Particular aspects of the subject matter described herein may be implemented to realize one or more advantages. The described techniques may support flexibility in full duplex slots such that a UE may select an appropriate interleaving configuration for a slot. This may result in improved decoding reliability and robustness, decreased device and system latency, or the like. As such, supported techniques may promote device and network efficiencies, among other benefits.

Aspects of the disclosure are initially described in the context of wireless communications systems. Additionally, or alternatively, aspects of the disclosure are illustrated through a resource structure and a process flow. Aspects of the disclosure are further illustrated by and described with reference to apparatus diagrams, system diagrams, and flowcharts that relate to virtual RB to physical RB mapping in duplex slots.

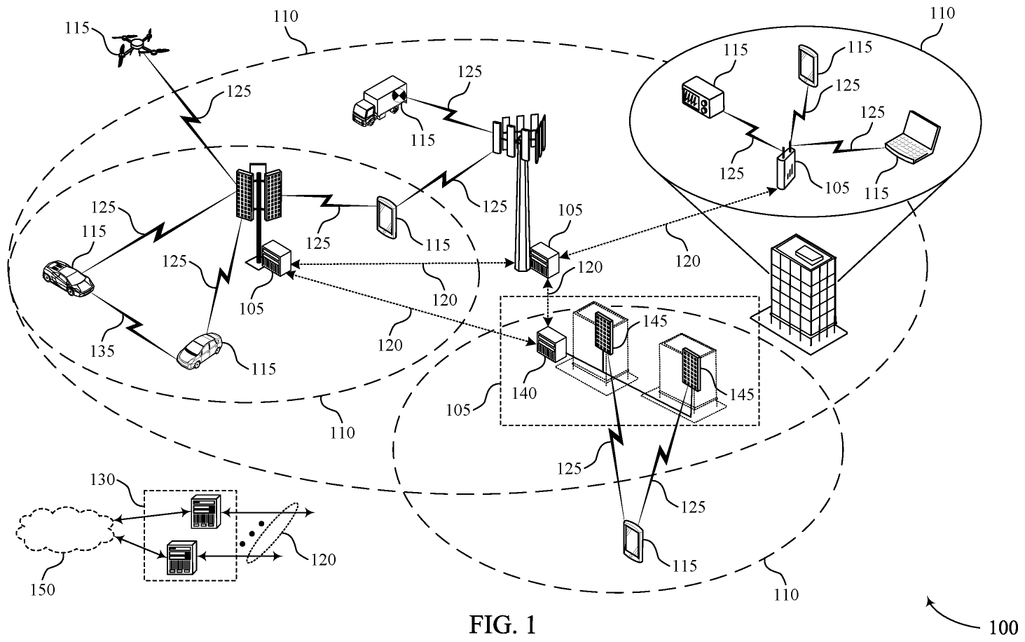

FIG. 1 illustrates an example of a wireless communications system 100 that supports virtual RB to physical RB mapping in duplex slots in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a BWP) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half duplex communications (e.g., a mode that supports one-way communication via transmission or reception, but not transmission and reception simultaneously). In some examples, half duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or RBs) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some cases, a UE 115 in the wireless communications system 100 may communicate with an additional device (e.g., a base station 105, an additional UE 115, etc.) according to a full duplex configuration, where a first transmission direction occurs at a same time as a second transmission direction within a slot configured for the full duplex configuration, the first transmission direction being different than the second transmission direction. Based on the two transmission directions occurring at the same time, the UE 115 (e.g., and additional devices using a full duplex configuration) may experience a self-interference. For example, the second transmission direction (e.g., downlink communications, uplink communications, etc.) may impact the first transmission direction (e.g., uplink communications, downlink communications, etc.), thereby reducing the ability of the UE 115 to successfully communicate in both transmission directions at the same time. Further, the UE 115 or the additional device may apply an interleaving configuration to communications in the slot. However, use of the configuration may not be consistent across all devices or all communications.

The UE 115 may determine or select an interleaver configuration for communications in a transmission direction with the additional device. The interleaving configuration may include a frequency domain interleaving configuration, a virtual RB-to-physical RB mapping configuration, or a combination thereof for the communications in the transmission direction. For example, the UE 115 may assume that a half duplex interleaving configuration is used for half duplex slots and a full duplex interleaving configuration is used for full duplex slots. Alternatively, the base station may include an indication of the configuration in a transmission (e.g., downlink control information (DCI)) to the UE 115. In some cases, the selection of the configuration may depend on the uplink and downlink BWPs scheduled for respective uplink and downlink transmissions within a full duplex slot. For instance, if the downlink BWP is located close (e.g., in frequency) to the uplink BWP, the UE 115 may experience self-interference, which may be mitigated by selecting a full duplex interleaving configuration for the slot.

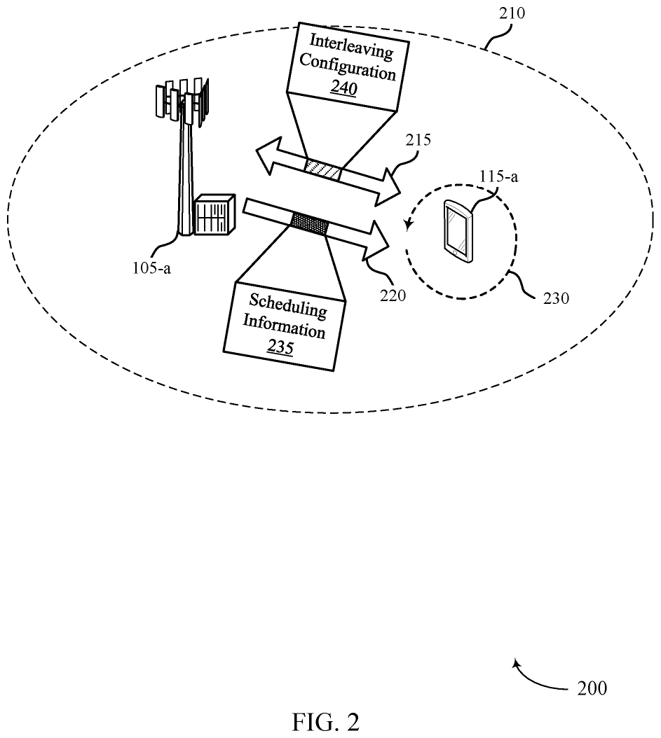

FIG. 2 illustrates an example of a wireless communications system 200 that supports virtual RB to physical RB mapping in duplex slots in accordance with aspects of the present disclosure. In some examples, wireless communications system 200 may implement aspects of wireless communications system 100. and may include a UE 115-a, a base station 105-a with a coverage area 210, and communication links 115-a and 220, which may be examples of a UE 115, base station 105, coverage area 110, and communication link 125, respectively, described with reference to FIG. 1.

For example, base station 105-a may transmit scheduling information 235 over a communication link 220. Further, UE 115-a may communicate according to a full duplex mode in which UE 115-a receives a downlink message from base station 105-a via communication link 215 while transmitting an uplink message to base station 105-a via communication link 215. However, the downlink message and uplink message may cause self-interference 230 at UE 115-a. In some cases, UE 115-a or base station 105-a may apply an interleaving configuration 240 to the uplink message or the downlink message, which may reduce self-interference 230 at UE 115-a.

In some cases, one or more wireless devices (e.g., base station 105-a or UEs 115) may communicate with one or more other wireless devices according to a full duplex mode. For example, a base station 105 (e.g., base station 105-a) may transmit a downlink signal to one or more UEs 115 (such as UE 115-a) while receiving an uplink signal (e.g., from at least one of the one or more UEs 115 or receiving an additional signal from an additional device), which may result in downlink to uplink self-interference at the base station 105-a (e.g., due to a proximity of reception and transmission antennas). Additionally, or alternatively, a UE 115-a may receive a downlink signal from a base station 105-a while transmitting an uplink signal to a base station 105-a (e.g., or the UE 115-a may receive/transmit additional types of signals, such as sidelink signals, that impact other signaling at the UE 115-a), which may result in uplink to downlink self-interference at the UE 115-a (e.g., as illustrated in FIG. 2 with self-interference 230). While downlink to uplink self-interference and uplink to downlink self-interference are described, different types of signaling in a first transmission direction for a device (e.g., UE 115-a, base station 105-a, etc.) may cause or be affected by self-interference from signaling in a second transmission direction occurring at a same time that is different than the first transmission direction.

In some examples, the UE 115-a and the base station 105-a may operate according to a full duplex type. For example, the UE 115-a and the base station 105-a may communicate using in-band full duplex (IBFD) in which the time and frequency resources for an uplink message and a downlink message may fully or partially overlap. For example, UE 115-a and base station 105-a may transit and receive messages with same time and frequency resources. In some other examples, the UE 115-a and the base station 105-a may operate using sub-band FDD in which the UE 115-a and the base station 105-a may transmit and receive messages at the same time, but with different frequency resources. Thus, the downlink resources may be separated from the uplink resource in the frequency domain. However, in IBFD and sub-band FDD, the uplink message and downlink message may interfere, for example due to the overlapping resources in IBFD or leakage between uplink and downlink in sub-band FDD, which may result in self-interference 230 at the UE 115-a or a self-interference at the base station 105-a.

In some cases, techniques may be used for interference mitigation at the UE 115-a or the base station 105-a to reduce the effects of self-interference from full duplex operations. For example, one or more different antenna panels may be used for transmission and reception operations. A communication band may have a number of slots (e.g., four slots), each slot including any number of time-frequency resources. A first antenna panel may be used for transmission in a first direction (e.g., transmitting downlink communications, transmitting uplink communications) at the edges of the band (e.g., the first and last slot). A second antenna panel may be used for reception in a second direction (e.g., receiving uplink communications, receiving downlink communications, etc.) in the middle of the band (e.g., the second and third slot). Using a first and second antenna panel (e.g., different antenna panels) may improve isolation (e.g., for communication with isolation greater than 50 decibels (dB)). In some examples, such as sub-band full duplex operation (e.g., for isolation greater than 40 dB), downlink and uplink transmissions (e.g., or transmissions in other directions) may occur during different slots of the communication band. There may be leakage between the uplink and downlink transmissions. To mitigate the leakage, a receive windowed overlap-and-add (WOLA) may be introduced to reduce the dynamic range of the adjacent channel leakage ratio (ACLR). Additionally, or alternatively, an analog low-pass filter may be introduced to improve the dynamic range of the analog to digital converter. In some cases, improving the receive automatic gain control (AGC) states may improve the noise figure. For interference mitigation (e.g., for isolation greater than 20 dB), a digital integrated circuit of the ACLR leakage may include a non-linear model for each reception and transmission pair.

In some examples, the self-interference may be predictable in a full duplex slot. For example, the downlink RBs on an edge of an uplink communication band may experience relatively high interference, or the uplink RBs on an edge of a downlink communication band may experience relatively high interference. As the gap between a RB and a communication band, or a slot, with an opposite communication direction increases (e.g., in frequency), the interference level may decrease. However, frequency domain interleaving, virtual RB to physical RB mapping, or both may not account for the predictability of self-interference, Further, the base station 105-a may determine to use an interleaving configuration different than the interleaving configuration expected by the UE 115-a for a given transmission, which may result in the UE 115-a improperly decoding the transmission. In some cases, this may result in system inefficiencies, high signaling overhead (e.g., due to retransmissions), or both.

As described herein, wireless communications system 200 may support the use of techniques that enable UE 115-a to determine an interleaving configuration (e.g., interleaving configuration 240). The UE 115-a may receive, via communication link 220, scheduling information 235 indicating resources for an uplink transmission and a downlink transmission. Scheduling information 235 may also include an indication of one or more BWPs for each transmission. UE 115-a may select an interleaving configuration based on the scheduling information or the BWPs, among other examples. In some cases, base station 105-a may select the interleaving configuration and indicate it to the UE 115-a (e.g., via communication link 215). UE 115-a may use the interleaving configuration 240 to communicate the uplink transmission and downlink transmission with base station 105-a.

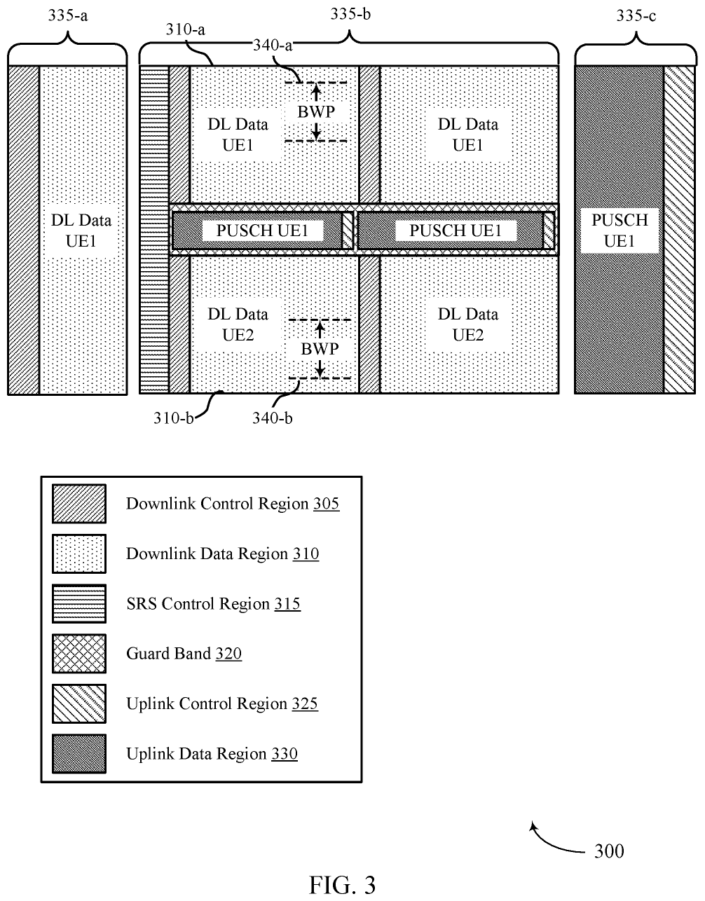

FIG. 3 illustrates an example of a resource structure 300 that supports virtual RB to physical RB mapping in duplex slots in accordance with aspects of the present disclosure. In some examples, resource structure 300 may implement aspects of wireless communications systems 100 and 200. For example, a UE (e.g., a UE 115 as described with reference to FIG. 1 and FIG. 2) may determine a resource structure 300 for full duplex communications with a base station (e.g., a base station 105 as described with reference to FIG. 1 and FIG. 2) or another UE. The resource structure 300 may represent a set of time and frequency resources for communication between the UE and the base station or other UE.

The resource structure 300 may include slots 335. Each slot 335 may include one or more uplink transmissions and one or more downlink transmissions, which may share time-frequency resources. The downlink transmissions may include downlink control regions 305 and downlink data regions 310. Similarly, the uplink transmissions may include uplink control regions 325 and uplink data regions 330. Control regions 305 and 325 may include, for example, time-frequency resource allocations, BWP information (e.g., BWP location, BWP allocation information, etc.), or the like, for each respective data region 310 and 330.

Slots 335 may represent a configured time for communication between the UE and the base station or other UE. For example, each slot 335 may be considered a TTI, one or more consecutive symbols (e.g., OFDM symbols), or a different length duration of time. Each slot 335 may be configured according to a communication type. For example, slots 335-a and 335-c may be configured for half duplex communications (e.g., uplink transmissions or downlink transmissions at a given time), where slot 335-a may include a downlink control region 305 and a downlink data transmission (e.g., a physical downlink shared channel (PDSCH)) in downlink data region 310, and slot 335-c may include an uplink control region 325 and an uplink data transmission (e.g., a physical uplink shared channel (PUSCH)) in uplink data region 330. Slot 335-b may be configured for full duplex communications (e.g., both uplink transmissions and downlink transmissions at a given time). For example, slot 335-b may include downlink control regions 305, corresponding downlink data regions 310, uplink control regions 325, and corresponding uplink data regions 330, which may share the same time-frequency resources. Slot 335-b may also include a guard band 320, which may be located between downlink and uplink regions (e.g., to reduce interference between downlink and uplink transmissions).

The downlink data regions 310 and uplink data regions 330 in full duplex slot 335-b may include one or more resource allocations for a corresponding transmission (e.g., an uplink data region 330 may include a resource allocation for an uplink transmission, a downlink data region 310 may include a resource allocation for a downlink transmission, etc.). In some cases, the resource allocation may be located within a BWP 340. In some examples, slot 335-b may also include a sounding reference signal (SRS) region 315.

A full duplex slot (e.g., slot 335-b) may, in some cases, include data regions for one or more UEs. For example, slot 335-b may include a first band configured for downlink communications for a first UE, and a second band configured for downlink communications for a second UE. In some cases, slot 335-b may have multiple bands configured for downlink communications for the same UE (e.g., the first UE).

A frequency domain interleaving for downlink transmissions in downlink data regions 310 or uplink transmissions in uplink data regions 330 may be applied based on a mapping, such as a virtual RB to physical RB mapping. In some cases, the interleaving may be applied to reduce self-interference at the transmitting and receiving devices. The base station or UE may apply the interleaving using an interleaving configuration, which may be based on one or more conditions. For example, the interleaving configuration may be applied based on whether the slot is a full duplex slot or a half duplex slot.

According to the techniques described herein, a UE may determine an interleaving configuration to use for communications within a given slot. The UE may receive scheduling information (e.g., in a downlink control region 305) for an uplink transmission and a downlink transmission in a slot. The scheduling information may indicate, or the UE may otherwise determine, that the slot is configured for full duplex communications, and the UE may select an interleaving configuration accordingly. For example, the UE may select a full duplex interleaving configuration for a full duplex slot (e.g., slot 335-b) and a half duplex interleaving configuration for a half duplex slot (e.g., slot 335-a, slot 335-c, or both).

In some cases, the base station may indicate the interleaving configuration in control information, e.g., in a downlink control region 305. The indication may be, for example, a one bit indicator within DCI, or an RRC message. The base station may select the interleaving configuration based on performance, capability information, or the like. For example, the base station may select a half duplex interleaving configuration if the receiving UE does not support full duplex interleaving configurations. After selecting the interleaving configuration, the UE and the base station (or other device) may communicate based on the interleaving configuration.

The UE may select the interleaving configuration based on a BWP or on resources allocated for a transmission within a BWP. For example, the UE may determine a BWP (e.g., a BWP 340-a) for a downlink transmission (e.g., based on the scheduling information received in a downlink control region 305). The BWP 340-a may be located within one or more bands configured for downlink communications, such as a downlink data region 310-a. The UE may also, in some cases, determine an uplink BWP for an uplink transmission (e.g., based on the scheduling information received in an uplink control region 325). The UE may determine the location of the downlink BWP 340-a relative to the uplink BWP. If the downlink BWP is close (e.g., in a frequency domain) to the uplink BWP, the likelihood of self-interference may increase. Accordingly, the UE may select a full duplex interleaving configuration to mitigate such self-interference. In some cases, the UE may select the configuration according to a threshold distance (e.g., in a frequency domain) between the downlink BWP 340-a and uplink BWP; that is, if the downlink BWP 340-a is located within the threshold distance from the uplink BWP, the UE may select the full duplex interleaving configuration (e.g., to mitigate self-interference, as described herein), while if the downlink BWP 340-a is located at or further than the threshold distance, the UE may select a half duplex interleaving configuration.

In some cases, the interleaving configuration may depend on the resource bandwidth of the BWP, or on the resource bandwidth allocated for the transmission within the BWP. For example, the resource bandwidth allocated for the transmission may span the entire BWP or may be a portion of the BWP. In either case, a large (e.g., in frequency) resource bandwidth may be close (e.g., in frequency) to an uplink data region 330, which may increase self-interference. Similarly, if the resource bandwidth allocated for the transmission within the BWP is located on a portion of the BWP that is close to an uplink data region 330, the risk of self-interference may increase. In both cases, the UE may determine an interleaving configuration (e.g., a full duplex interleaving configuration) that may reduce self-interference.

The UE may select the interleaving configuration according to the location of multiple BWPs (e.g., BWPs 340). The UE may determine multiple downlink BWPs 340 (e.g., based at least in part on scheduling information received in a downlink control region 305). The downlink BWPs 340 may be located within one or more bands configured for downlink communications. For example, downlink BWP 340-a may be located within downlink data region 310-a, and downlink BWP 340-b may be located within downlink data region 310-b. As illustrated, downlink data regions 310-a and 310-b are separated by a guard band 320 and an uplink data region 330. Because the BWPs 340 are located on both sides of an uplink data region 330 (e.g., which may contain an uplink transmission), the UE may select a full duplex interleaving configuration for the downlink transmissions allocated within BWPs 340. However, the UE may select an alternate interleaving configuration (e.g., a half duplex interleaving configuration) if the location of the BWPs 340 may not result in increased self-interference.

In some cases, a downlink transmission (e.g., a PDSCH) may be configured over multiple slots or multiple types of slots. In such cases, the UE may select an interleaving configuration based on a set of repetitions of the downlink transmission. For example, the UE may use a half duplex interleaving configuration for each slot configured for half duplex communications, and may use a full duplex interleaving configuration for each slot configured for full duplex communications. Additionally, or alternatively, the UE may select an interleaving configuration for a slot (e.g., of the multiple slots) according to the location of one or more downlink BWPs for a repetition of the set of repetitions. As described herein, the UE may select a half duplex interleaving configuration if a downlink BWP (e.g., a BWP 340) is located at or more than a threshold distance (e.g., in a frequency domain) from an uplink BWP for the uplink transmission. Alternatively, the UE may select a full duplex interleaving configuration if the one or more downlink BWPs are located within the threshold distance from the uplink BWP, or if the one or more downlink BWPs are located on both sides of an uplink BWP.

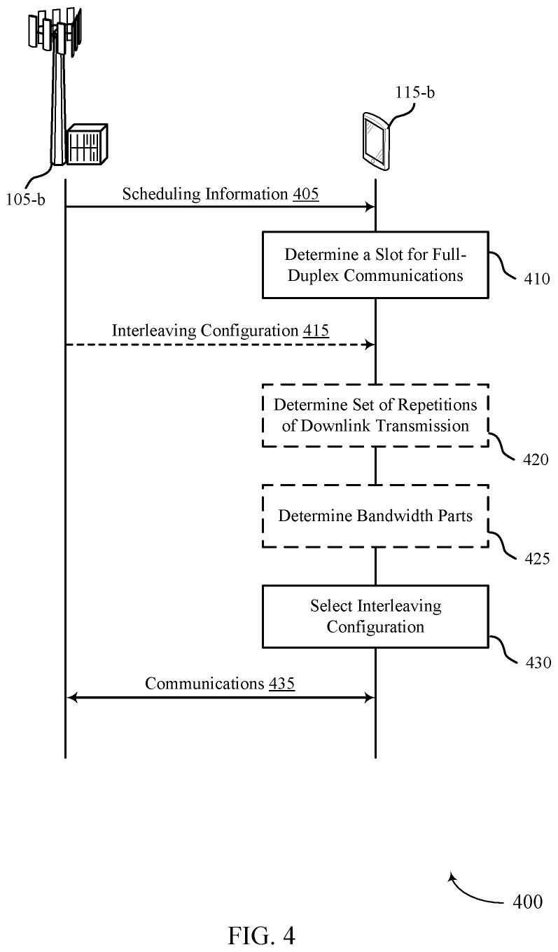

FIG. 4 illustrates an example of a process flow 400 that supports virtual RB to physical RB mapping in duplex slots in accordance with aspects of the present disclosure. In some examples, process flow 400 may implement aspects of wireless communications systems 100 and 200. For example, process flow 400 may include a device 105-b, which may be an example of a base station, a UE, or an additional wireless device described with reference to FIGS. 1-3. Additionally, or alternatively, process flow 400 may include a UE 115-b, which may be an example of a UE as described with reference to FIGS. 1-3.

In the following description of the process flow 400, the operations between UE 115-b and base station 105-b-b may be transmitted in a different order than the order shown, or the operations performed by UE 115-b and base station 105-b may be performed in different orders or at different times. Some operations may also be left out of the process flow 400, or other operations may be added to the process flow 400. It is to be understood that while UE 115-b and base station 105-b are shown performing a number of the operations of process flow 400, any wireless device may perform the operations shown.

At 405, base station 105-b may transmit scheduling information to UE 115-b. For example, the base station 105-b may transmit downlink control information (DCI) to the UE 115-b. The DCI may include resource allocation information (e.g., a set of time frequency resources) for one or more uplink transmissions, one or more downlink transmissions, or both. The DCI may also indicate one or more BWPs for each transmission and, in some cases, may include the location of each BWP. In some examples, the scheduling information may include an indication of an interleaving configuration for the UE 115-b to use. The indication may, for example, be a one bit indicator within the DCI.

At 410, UE 115-b may determine a slot (e.g., a configured transmission duration) for full duplex communications with base station 105-b that includes a first transmission direction occurring at a same time as a second transmission direction within the slot, the first transmission direction being different from the second transmission direction. The determination may be based on the scheduling information received at 405. In some cases, base station 105-b may also determine the slot for the full duplex communications with UE 115-b. For example, the first transmission direction may include uplink communications, downlink communications, or sidelink communications, and the second transmission direction may include uplink communications, downlink communications, or sidelink communications that is different than the first transmission direction.

At 415, UE 115-b may optionally receive, from base station 105-b, an indication of an interleaving configuration for the communications in the first transmission direction (e.g., a downlink transmission) with base station 105-b. In some cases, UE 115-b may receive, from base station 105-b, the indication of the interleaving configuration via RRC signaling.

At 420, UE 115-b may determine a set of repetitions of one or more downlink transmissions, which may be based on the scheduling information received at 405. The set of repetitions may span multiple slots including the slot determined at 410.

At 425, UE 115-b may determine a BWP for a downlink transmission scheduled at 405, an uplink transmission scheduled at 405, or both. In some cases, UE 115-b may determine multiple BWPs for the downlink transmission. The BWPs may be determined based on the scheduling information received at 405.

At 430, UE 115-b (e.g., and base station 105-b) may select an interleaving configuration for the communications in the full duplex slot based on the scheduling information, the determined slot, the interleaving configuration indication, the set of repetitions, the determined BWPs, a resource bandwidth, or some combination thereof. For example, the UE 115-b may use the interleaving configuration indicated by the base station 105-b (e.g., at 405 or at 415). Alternatively, the UE 115-b may select the configuration based on the location of the downlink BWP within a set of bands configured for downlink communications or on the location of the downlink BWP relative to the uplink BWP (e.g., in a frequency domain). In cases where the UE 115-b has determined multiple downlink BWPs for the downlink transmission, the interleaving configuration may be selected based on respective locations of the multiple downlink BWPs within a set of bands configured for downlink communications.

UE 115-b may, in some cases, select the interleaving configuration based on a resource bandwidth allocated for a transmission within a BWP. Base station 105-b may, at 405, indicate a resource allocation for an uplink or downlink transmission within the corresponding uplink or downlink BWP. As described herein, UE 115-b may select the interleaving configuration based on, for example, the size of the resource bandwidth allocation (e.g., relative to the size of the BWP) or the location of the resource allocation (e.g., relative to other BWPs, such as an uplink BWP).

In some examples, the UE 115-b may select a half duplex interleaving configuration or a full duplex interleaving configuration. For instance, the UE 115-b may select a half duplex interleaving configuration if the downlink BWP is located a threshold distance (e.g., in a frequency domain) from the uplink BWP for the uplink transmission, and may select a full duplex interleaving configuration if the downlink BWP is located within the threshold distance. Similarly, the UE 115-b may choose a full duplex interleaving configuration if the respective locations of the multiple downlink BWPs are positioned on both sides of an uplink BWP of the uplink transmission (e.g., in a frequency domain). In some cases, the UE 115-b may select the interleaving configuration according to the type of slot (e.g., a full duplex interleaving configuration for a full duplex slot).

If, at 420, the UE 115-b has determined that a set of repetitions of the downlink transmission spans multiple slots including the slot determined at 410, the UE 115-b may, at 430, select interleaving configurations for each of the multiple slots. As an example, UE 115-b may choose to use a half duplex interleaving configuration for each slot configured for half duplex communications and a full duplex interleaving configuration for each slot configured for full duplex communications. In some cases, UE 115-b may instead determine, for a repetition of the set of repetitions in a full duplex slot (e.g., of the multiple slots), one or multiple downlink BWPs, and may select the interleaving configuration based on the location of the one or multiple downlink BWPs. For example, the UE 115-b may select, for the full duplex slot, a half duplex interleaving configuration if the downlink BWP is located a threshold distance (e.g., in a frequency domain) from an uplink BWP for the uplink transmission, or a full duplex interleaving configuration if multiple downlink BWPs are positioned on both sides of the uplink BWP (e.g., in a frequency domain). In some case, the UE 115-b may select the half duplex interleaving configuration upon receiving an indication to do so from the base station 105-b (e.g., at 415).

In some examples, the base station 105-b may determine a set of repetitions (e.g., at 420) or BWPs (e.g., at 425), and may select the interleaving configuration (e.g., based on the scheduling information, the determined slot, the interleaving configuration indication, the set of repetitions, the determined BWPs, a resource bandwidth, or some combination thereof). The base station 105-b may communicate the selection to the UE 115-b.

At 435, UE 115-b may communicate with base station 105-b based on the interleaving configuration.

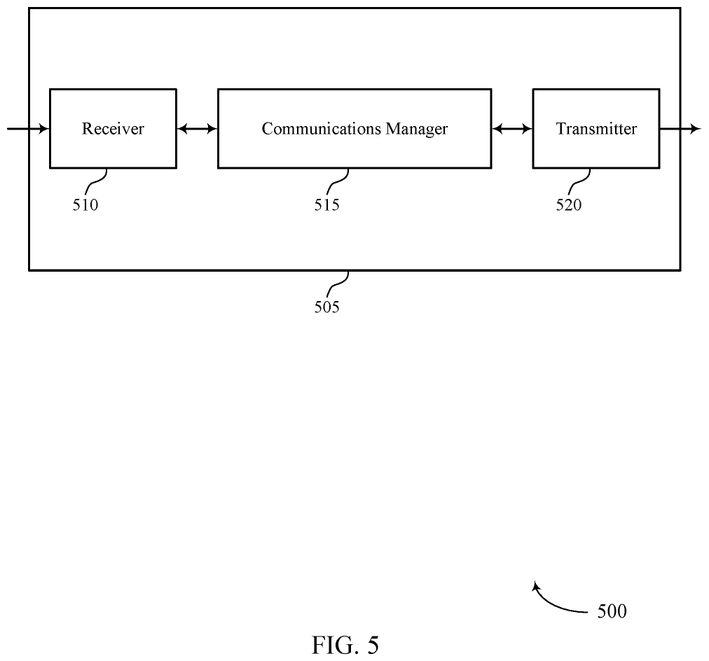

FIG. 5 shows a block diagram 500 of a device 505 that supports virtual RB to physical RB mapping in duplex slots in accordance with aspects of the present disclosure. The device 505 may be an example of aspects of a UE 115 as described herein. The device 505 may include a receiver 510, a communications manager 515, and a transmitter 520. The device 505 may also include a processor. Each of these components may be in communication with one another (e.g., via one or more buses).

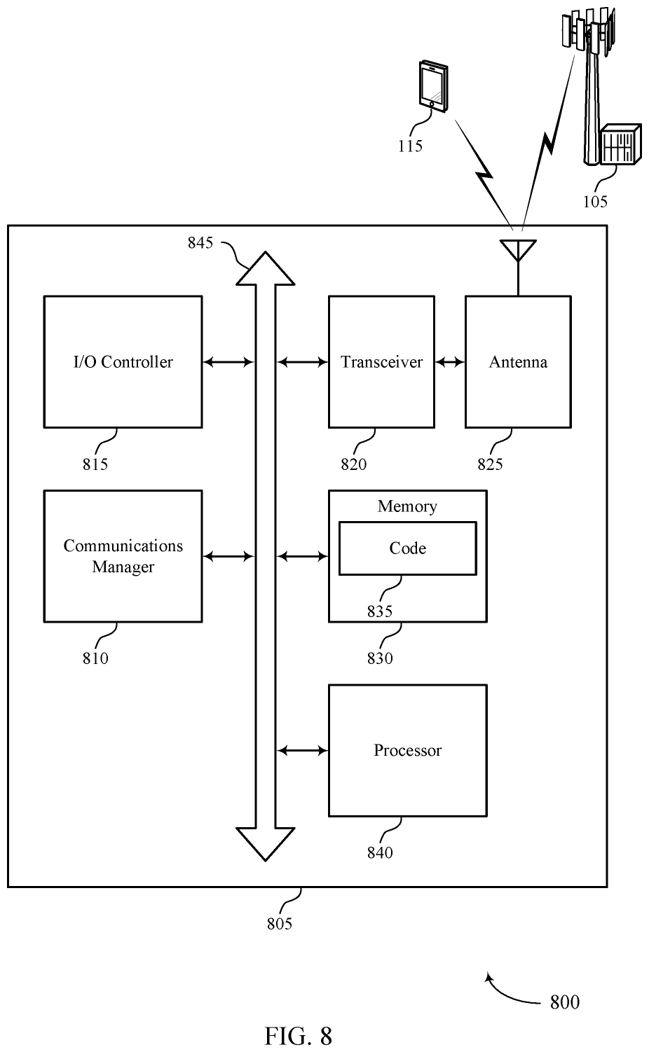

The receiver 510 may receive information such as packets, user data, or control information associated with various information channels (e.g., control channels, data channels, and information related to virtual RB to physical RB mapping in duplex slots, etc.). Information may be passed on to other components of the device 505. The receiver 510 may be an example of aspects of the transceiver 820 described with reference to FIG. 8. The receiver 510 may utilize a single antenna or a set of antennas.

The communications manager 515 may receive, from a base station, scheduling information for an uplink transmission and a downlink transmission. The communications manager 515 may determine that a slot is configured for full duplex communications with the base station based on the scheduling information. The communications manager 515 may select an interleaving configuration for the full duplex communications in the slot based on the scheduling information and determining that the slot is configured for full duplex communications. The communications manager 515 may communicate with the base station in the slot based on the interleaving configuration. The communications manager 515 may be an example of aspects of the communications manager 810 described herein.

The communications manager 515, or its sub-components, may be implemented in hardware, code (e.g., software or firmware) executed by a processor, or any combination thereof. If implemented in code executed by a processor, the functions of the communications manager 515, or its sub-components may be executed by a general-purpose processor, a digital signal processor (DSP), an application-specific integrated circuit (ASIC), a field programmable gate array (FPGA), or other programmable logic device, discrete gate or transistor logic, discrete hardware components, or any combination thereof designed to perform the functions described in the present disclosure.

The communications manager 515, or its sub-components, may be physically located at various positions, including being distributed such that portions of functions are implemented at different physical locations by one or more physical components. In some examples, the communications manager 515, or its sub-components, may be a separate and distinct component in accordance with various aspects of the present disclosure. In some examples, the communications manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 520 may transmit signals generated by other components of the device 505. In some examples, the transmitter 520 may be collocated with a receiver 510 in a transceiver module. For example, the transmitter 520 may be an example of aspects of the transceiver 820 described with reference to FIG. 8. The transmitter 520 may utilize a single antenna or a set of antennas.

In some examples, the communications manager 515 may be implemented as an integrated circuit or chipset for a mobile device modem, and the receiver 510 and transmitter 520 may be implemented as analog components (e.g., amplifiers, filters, antennas) coupled with the mobile device modem to enable wireless transmission and reception over one or more bands.

The communications manager 515 as described herein may be implemented to realize one or more potential advantages. One implementation may allow the device 505 to determine an interleaving configuration used for communications in full duplex resources between the device 505 and a base station. Based on the techniques for determining the interleaving configuration, the device 505 may more accurately decode transmissions in full duplex resources.

As such, the device 505 may increase the likelihood of accurately decoding transmissions and, accordingly, may communicate over the channel with a greater likelihood of successful communications. In some examples, based on a greater likelihood of successful communications, the device 505 may more efficiently power a processor or one or more processing units associated with transmitting and receiving communications, which may enable the device to save power and increase battery life.

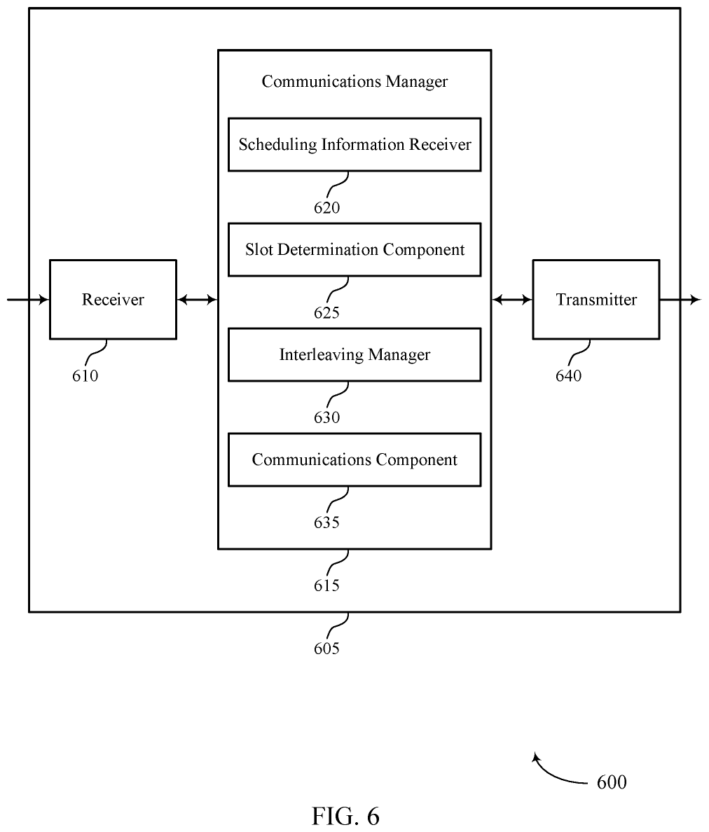

FIG. 6 shows a block diagram 600 of a device 605 that supports virtual RB to physical RB mapping in duplex slots in accordance with aspects of the present disclosure. The device 605 may be an example of aspects of a device 505, or a UE 115 as described herein. The device 605 may include a receiver 610, a communications manager 615, and a transmitter 640. The device 605 may also include a processor. Each of these components may be in communication with one another (e.g., via one or more buses).

The receiver 610 may receive information such as packets, user data, or control information associated with various information channels (e.g., control channels, data channels, and information related to virtual RB to physical RB mapping in duplex slots, etc.). Information may be passed on to other components of the device 605. The receiver 610 may be an example of aspects of the transceiver 820 described with reference to FIG. 8. The receiver 610 may utilize a single antenna or a set of antennas.

The communications manager 615 may be an example of aspects of the communications manager 515 as described herein. The communications manager 615 may include a scheduling information receiver 620. The communications manager may include a slot determination component 625. The communications manager may include an interleaving manager 630 The communications manager may include a communications component 635. The communications manager 615 may be an example of aspects of the communications manager 810 described herein.

The scheduling information receiver 620 may receive, from a base station, scheduling information for an uplink transmission and a downlink transmission.

The slot determination component 625 may determine that a slot is configured for full duplex communications with the base station based on the scheduling information.

The interleaving manager 630 may select an interleaving configuration for the full duplex communications in the slot based on the scheduling information and determining that the slot is configured for full duplex communications.

The communications component 635 may communicate with the base station in the slot based on the interleaving configuration.

The transmitter 640 may transmit signals generated by other components of the device 605. In some examples, the transmitter 640 may be collocated with a receiver 610 in a transceiver module. For example, the transmitter 640 may be an example of aspects of the transceiver 820 described with reference to FIG. 8. The transmitter 640 may utilize a single antenna or a set of antennas.

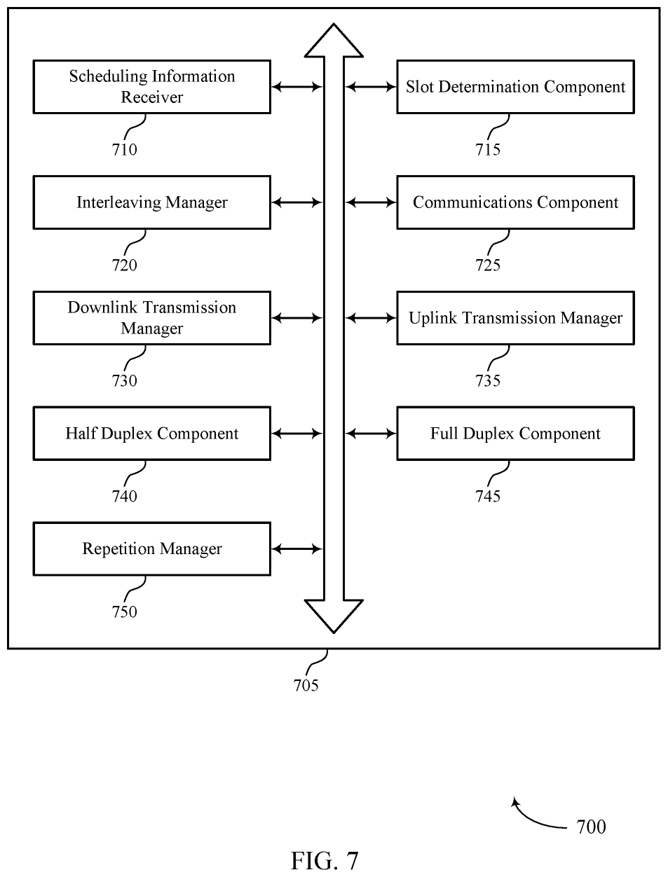

FIG. 7 shows a block diagram 700 of a communications manager 705 that supports virtual RB to physical RB mapping in duplex slots in accordance with aspects of the present disclosure. The communications manager 705 may be an example of aspects of a communications manager 515, a communications manager 615, or a communications manager 810 described herein. The communications manager 705 may include a scheduling information receiver 710. The communications manager 705 may include a slot determination component 715. The communications manager 705 may include an interleaving manager 720. The communications manager 705 may include a communications component 725. The communications manager 705 may include a downlink transmission manager 730. The communications manager 705 may include an uplink transmission manager 735. The communications manager 705 may include a half duplex component 740. The communications manager 705 may include a full duplex component 745. The communications manager 705 may include a repetition manager 750. Each of these modules may communicate, directly or indirectly, with one another (e.g., via one or more buses).

The scheduling information receiver 710 may receive, from a base station, scheduling information for an uplink transmission and a downlink transmission.

In some examples, the scheduling information receiver 710 may receive an indication of the interleaving configuration, where selecting the interleaving configuration is based on the indication.

In some cases, the indication is a one bit indicator within downlink control information.

The slot determination component 715 may determine that a slot is configured for full duplex communications with the base station based on the scheduling information.

The interleaving manager 720 may select an interleaving configuration for the full duplex communications in the slot based on the scheduling information and determining that the slot is configured for full duplex communications.

In some examples, the interleaving manager 720 may select the interleaving configuration based on a location of the downlink BWP and the downlink resource bandwidth within a set of bands configured for downlink communications.

In some examples, the interleaving manager 720 may select the interleaving configuration based on a location of the downlink BWP relative to the uplink BWP in a frequency domain or a location of the downlink resource bandwidth relative to the uplink resource bandwidth in the frequency domain.

In some examples, the interleaving manager 720 may select the interleaving configuration based on respective locations of the multiple downlink BWPs within a set of bands configured for downlink communications.

The communications component 725 may communicate with the base station in the slot based on the interleaving configuration.

The downlink transmission manager 730 may determine a downlink BWP and a downlink resource bandwidth for the downlink transmission based on the scheduling information, where the interleaving configuration is selected based on the downlink BWP and the downlink resource bandwidth.

In some examples, the downlink transmission manager 730 may determine multiple downlink BWPs for the downlink transmission based on the scheduling information.

In some examples, the downlink transmission manager 730 may determine a downlink BWP and a downlink resource bandwidth for a repetition of the set of repetitions in a full duplex slot of the multiple slots.

In some examples, the downlink transmission manager 730 may determine multiple downlink BWPs for a repetition of the set of repetitions in a full duplex slot of the multiple slots.

The uplink transmission manager 735 may determine an uplink BWP and an uplink resource bandwidth for the uplink transmission based on the scheduling information.

The half duplex component 740 may select a half duplex interleaving configuration based at least in part on the downlink BWP being located a threshold distance in a frequency domain apart from an uplink BWP for the uplink transmission or the downlink resource bandwidth being located the threshold distance in the frequency domain apart from an uplink resource bandwidth for the uplink transmission.

In some examples, the half duplex component 740 may select a half duplex interleaving configuration for each slot of the multiple slots configured for half duplex communications.

In some examples, the half duplex component 740 may select a half duplex interleaving configuration for the full duplex slot based on the downlink BWP being located a threshold distance in a frequency domain apart from an uplink BWP for the uplink transmission or the resource bandwidth being located the threshold distance in the frequency domain apart from an uplink resource bandwidth for the uplink transmission.

In some examples, the half duplex component 740 may receive a message indicating the half duplex interleaving configuration from the base station, where the half duplex interleaving configuration is selected based on the message.

The full duplex component 745 may select a full duplex interleaving configuration based at least in part on the downlink BWP being located within a threshold distance in a frequency domain from an uplink BWP for the uplink transmission or the downlink resource bandwidth being located within the threshold distance in the frequency domain from an uplink resource bandwidth for the uplink transmission.

In some examples, the full duplex component 745 may select a full duplex interleaving configuration based on the respective locations being positioned on both sides of an uplink BWP for the uplink transmission in a frequency domain.

In some examples, the full duplex component 745 may select a full duplex interleaving configuration based on determining that the slot is configured for full duplex communications.

In some examples, the full duplex component 745 may select a full duplex interleaving configuration for each slot of the multiple slots configured for full duplex communications.

In some examples, the full duplex component 745 may select a full duplex interleaving configuration for the full duplex slot based on the multiple downlink BWPs being positioned on both sides of an uplink BWP for the uplink transmission in a frequency domain within the full duplex slot.

The repetition manager 750 may determine that a set of repetitions of the downlink transmission spans multiple slots including the slot based on the scheduling information, where the interleaving configuration is selected based on the set of repetitions.

FIG. 8 shows a diagram of a system 800 including a device 805 that supports virtual RB to physical RB mapping in duplex slots in accordance with aspects of the present disclosure. The device 805 may be an example of or include the components of device 505, device 605, or a UE 115 as described herein. The device 805 may include components for bi-directional voice and data communications including components for transmitting and receiving communications, including a communications manager 810, an I/O controller 815, a transceiver 820, an antenna 825, memory 830, and a processor 840. These components may be in electronic communication via one or more buses (e.g., bus 845).

The communications manager 810 may receive, from a base station, scheduling information for an uplink transmission and a downlink transmission. The communications manager 810 may determine that a slot is configured for full duplex communications with the base station based on the scheduling information. The communications manager 810 may select an interleaving configuration for the full duplex communications in the slot based on the scheduling information and determining that the slot is configured for full duplex communications. The communications manager 810 may communicate with the base station in the slot based on the interleaving configuration.

The I/O controller 815 may manage input and output signals for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS®, ANDROID®, MS-DOS®, MS-WINDOWS®, OS/2®, UNIX®, LINUX®, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The transceiver 820 may communicate bi-directionally, via one or more antennas, wired, or wireless links as described herein. For example, the transceiver 820 may represent a wireless transceiver and may communicate bi-directionally with another wireless transceiver. The transceiver 820 may also include a modem to modulate the packets and provide the modulated packets to the antennas for transmission, and to demodulate packets received from the antennas.

In some cases, the wireless device may include a single antenna 825. However, in some cases the device may have more than one antenna 825, which may be capable of concurrently transmitting or receiving multiple wireless transmissions.

The memory 830 may include random access memory (RAM) and read only memory (ROM). The memory 830 may store computer-readable, computer-executable code 835 including instructions that, when executed, cause the processor to perform various functions described herein. In some cases, the memory 830 may contain, among other things, a basic I/O system (BIOS) which may control basic hardware or software operation such as the interaction with peripheral components or devices.

The processor 840 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into the processor 840. The processor 840 may be configured to execute computer-readable instructions stored in a memory (e.g., the memory 830) to cause the device 805 to perform various functions (e.g., functions or tasks supporting virtual RB to physical RB mapping in duplex slots).

The code 835 may include instructions to implement aspects of the present disclosure, including instructions to support wireless communications. The code 835 may be stored in a non-transitory computer-readable medium such as system memory or other type of memory. In some cases, the code 835 may not be directly executable by the processor 840 but may cause a computer (e.g., when compiled and executed) to perform functions described herein.

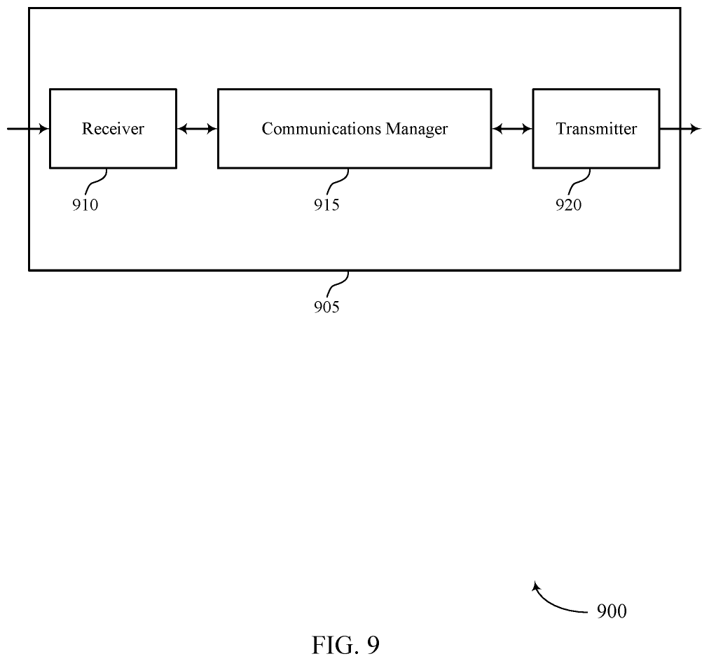

FIG. 9 shows a block diagram 900 of a device 905 that supports virtual RB to physical RB mapping in duplex slots in accordance with aspects of the present disclosure. The device 905 may be an example of aspects of a base station 105 as described herein. The device 905 may include a receiver 910, a communications manager 915, and a transmitter 920. The device 905 may also include a processor. Each of these components may be in communication with one another (e.g., via one or more buses).

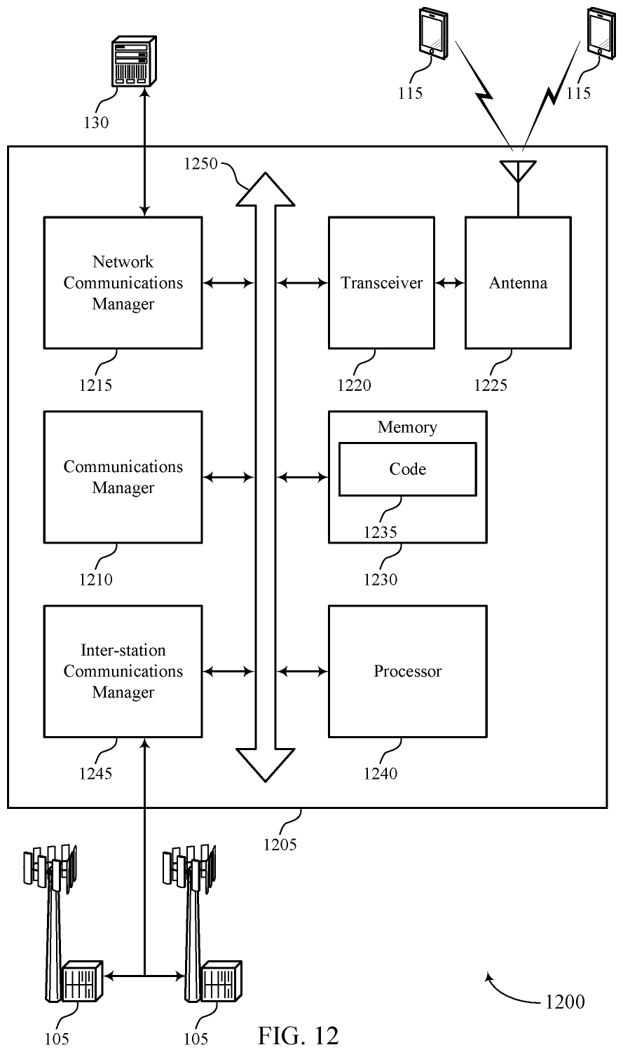

The receiver 910 may receive information such as packets, user data, or control information associated with various information channels (e.g., control channels, data channels, and information related to virtual RB to physical RB mapping in duplex slots, etc.). Information may be passed on to other components of the device 905. The receiver 910 may be an example of aspects of the transceiver 1220 described with reference to FIG. 12. The receiver 910 may utilize a single antenna or a set of antennas.

The communications manager 915 may determine that a slot is configured for full duplex communications with a UE based on an uplink transmission and a downlink transmission for the UE. The communications manager 915 may select an interleaving configuration for the full duplex communications in the slot based on determining that the slot is configured for full duplex communications. The communications manager 915 may communicate the uplink transmission and the downlink transmission with the UE based on the interleaving configuration. The communications manager 915 may be an example of aspects of the communications manager 1210 described herein.

The communications manager 915, or its sub-components, may be implemented in hardware, code (e.g., software or firmware) executed by a processor, or any combination thereof. If implemented in code executed by a processor, the functions of the communications manager 915, or its sub-components may be executed by a general-purpose processor, a DSP, an ASIC, an FPGA or other programmable logic device, discrete gate or transistor logic, discrete hardware components, or any combination thereof designed to perform the functions described in the present disclosure.

The communications manager 915, or its sub-components, may be physically located at various positions, including being distributed such that portions of functions are implemented at different physical locations by one or more physical components. In some examples, the communications manager 915, or its sub-components, may be a separate and distinct component in accordance with various aspects of the present disclosure. In some examples, the communications manager 915, or its sub-components, may be combined with one or more other hardware components, including but not limited to an I/O component, a transceiver, a network server, another computing device, one or more other components described in the present disclosure, or a combination thereof in accordance with various aspects of the present disclosure.

The transmitter 920 may transmit signals generated by other components of the device 905. In some examples, the transmitter 920 may be collocated with a receiver 910 in a transceiver module. For example, the transmitter 920 may be an example of aspects of the transceiver 1220 described with reference to FIG. 12. The transmitter 920 may utilize a single antenna or a set of antennas.

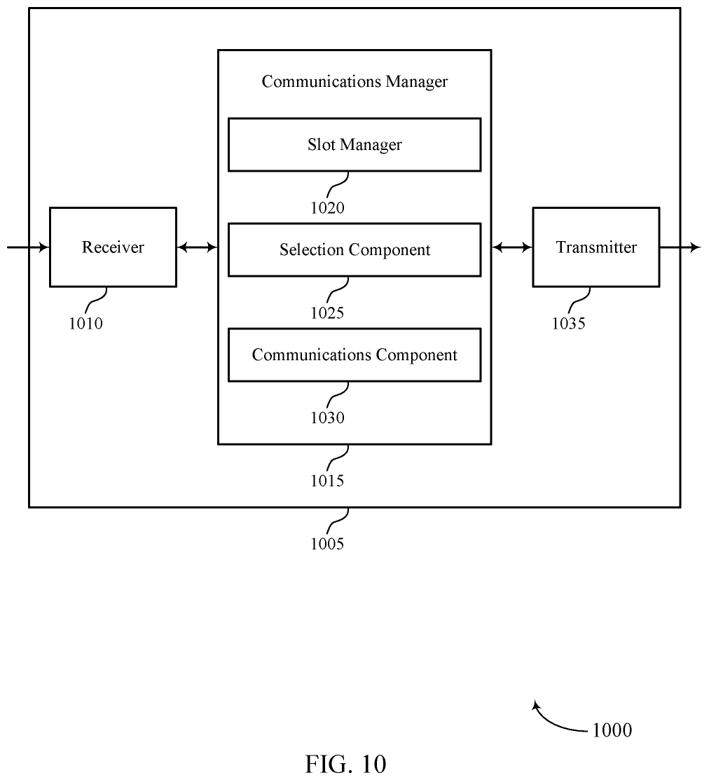

FIG. 10 shows a block diagram 1000 of a device 1005 that supports virtual RB to physical RB mapping in duplex slots in accordance with aspects of the present disclosure. The device 1005 may be an example of aspects of a device 905, or a base station 105 as described herein. The device 1005 may include a receiver 1010, a communications manager 1015, and a transmitter 1035. The device 1005 may also include a processor. Each of these components may be in communication with one another (e.g., via one or more buses).

The receiver 1010 may receive information such as packets, user data, or control information associated with various information channels (e.g., control channels, data channels, and information related to virtual RB to physical RB mapping in duplex slots, etc.). Information may be passed on to other components of the device 1005. The receiver 1010 may be an example of aspects of the transceiver 1220 described with reference to FIG. 12. The receiver 1010 may utilize a single antenna or a set of antennas.

The communications manager 1015 may be an example of aspects of the communications manager 915 as described herein. The communications manager 1015 may include a slot manager 1020. The communications manager 1015 may include a selection component 1025. The communications manager 1015 may include a communications component 1030. The communications manager 1015 may be an example of aspects of the communications manager 1210 described herein.

The slot manager 1020 may determine that a slot is configured for full duplex communications with a UE based on an uplink transmission and a downlink transmission for the UE.

The selection component 1025 may select an interleaving configuration for the full duplex communications in the slot based on determining that the slot is configured for full duplex communications.

The communications component 1030 may communicate the uplink transmission and the downlink transmission with the UE based on the interleaving configuration.

The transmitter 1035 may transmit signals generated by other components of the device 1005. In some examples, the transmitter 1035 may be collocated with a receiver 1010 in a transceiver module. For example, the transmitter 1035 may be an example of aspects of the transceiver 1220 described with reference to FIG. 12. The transmitter 1035 may utilize a single antenna or a set of antennas.

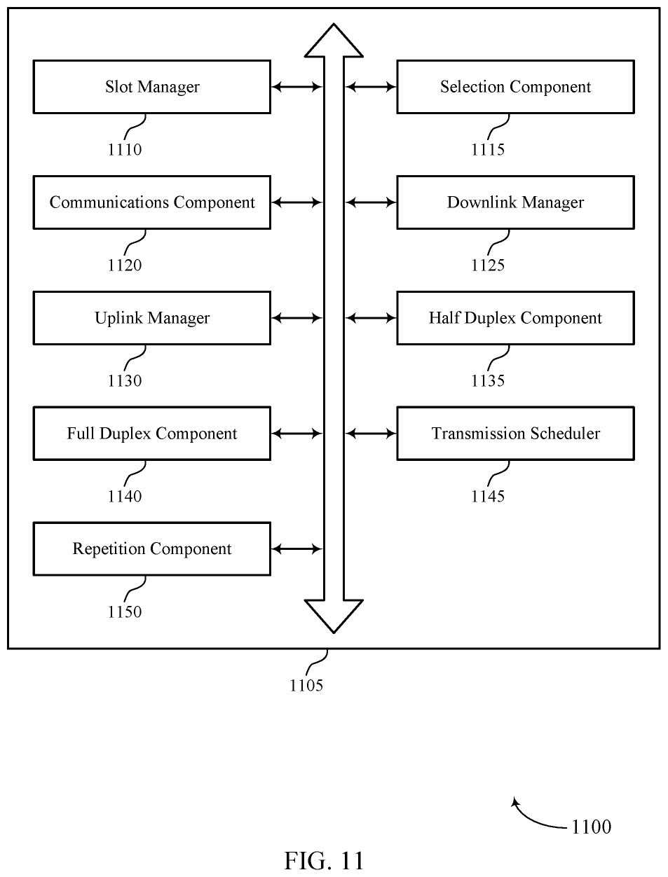

FIG. 11 shows a block diagram 1100 of a communications manager 1105 that supports virtual RB to physical RB mapping in duplex slots in accordance with aspects of the present disclosure. The communications manager 1105 may be an example of aspects of a communications manager 915, a communications manager 1015, or a communications manager 1210 described herein. The communications manager 1105 may include a slot manager 1110. The communications manager 1105 may include a selection component 1115. The communications manager 1105 may include a communications component 1120. The communications manager 1105 may include a downlink manager 1125. The communications manager 1105 may include an uplink manager 1130. The communications manager 1105 may include a half duplex component 1135. The communications manager 1105 may include a full duplex component 1140. The communications manager 1105 may include a transmission scheduler 1145. The communications manager 1105 may include a repetition component 1150. Each of these modules may communicate, directly or indirectly, with one another (e.g., via one or more buses).

The slot manager 1110 may determine that a slot is configured for full duplex communications with a UE based on an uplink transmission and a downlink transmission for the UE.

The selection component 1115 may select an interleaving configuration for the full duplex communications in the slot based on determining that the slot is configured for full duplex communications.

In some examples, the selection component 1115 may select the interleaving configuration based on a location of the downlink BWP or the downlink resource bandwidth within a set of bands configured for downlink communications.

In some examples, the selection component 1115 may select the interleaving configuration based on a location of the downlink BWP relative to the uplink BWP in a frequency domain or a location of the downlink resource bandwidth relative to the uplink resource bandwidth in the frequency domain.

In some examples, the selection component 1115 may select the interleaving configuration based on respective locations of the multiple downlink BWPs within a set of bands configured for downlink communications.

The communications component 1120 may communicate the uplink transmission and the downlink transmission with the UE based on the interleaving configuration.

The downlink manager 1125 may determine a downlink BWP and a downlink resource bandwidth for the downlink transmission, where the interleaving configuration is selected based on the downlink BWP and the downlink resource bandwidth.

In some examples, the downlink manager 1125 may determine multiple downlink BWPs for the downlink transmission.

In some examples, the downlink manager 1125 may determine a downlink BWP and a downlink resource bandwidth for a repetition of the set of repetitions in a full duplex slot of the multiple slots.

In some examples, the downlink manager 1125 may determine multiple downlink BWPs for a repetition of the set of repetitions in a full duplex slot of the multiple slots.

The uplink manager 1130 may determine an uplink BWP and an uplink resource bandwidth for the uplink transmission.

The half duplex component 1135 may select a half duplex interleaving configuration based at least in part on the downlink BWP being located a threshold distance in a frequency domain apart from an uplink BWP for the uplink transmission or the downlink resource bandwidth being located the threshold distance in the frequency domain apart from an uplink resource bandwidth for the uplink transmission.

In some examples, the half duplex component 1135 may select a half duplex interleaving configuration for each slot of the multiple slots configured for half duplex communications.

In some examples, the half duplex component 1135 may select a half duplex interleaving configuration for the full duplex slot based on the downlink BWP being located a threshold distance in a frequency domain apart from an uplink BWP for the uplink transmission or the downlink resource bandwidth being located the threshold distance in the frequency domain apart from an uplink resource bandwidth for the uplink transmission.

In some examples, receiving a message indicating the half duplex interleaving configuration to the UE, where the message includes a downlink control message or a radio resource control message.

The full duplex component 1140 may select a full duplex interleaving configuration based on the respective locations being positioned on both sides of an uplink BWP for the uplink transmission in a frequency domain.

In some examples, the full duplex component 1140 may select a full duplex interleaving configuration based on determining that the slot is configured for full duplex communications.

In some examples, the full duplex component 1140 may select a full duplex interleaving configuration for each slot of the multiple slots configured for full duplex communications.

In some examples, the full duplex component 1140 may select a full duplex interleaving configuration for the full duplex slot based on the multiple downlink BWPs being positioned on both sides of an uplink BWP for the uplink transmission in a frequency domain within the full duplex slot.

The transmission scheduler 1145 may transmit, to the UE, scheduling information for the uplink transmission and the downlink transmission, where the scheduling information indicates the interleaving configuration.

In some cases, the scheduling information includes a one bit indicator within downlink control information that indicates the interleaving configuration.

The repetition component 1150 may determine that a set of repetitions of the downlink transmission spans multiple slots including the slot, where the interleaving configuration is selected based on the set of repetitions.

FIG. 12 shows a diagram of a system 1200 including a device 1205 that supports virtual RB to physical RB mapping in duplex slots in accordance with aspects of the present disclosure. The device 1205 may be an example of or include the components of device 905, device 1005, or a base station 105 as described herein. The device 1205 may include components for bi-directional voice and data communications including components for transmitting and receiving communications, including a communications manager 1210, a network communications manager 1215, a transceiver 1220, an antenna 1225, memory 1230, a processor 1240, and an inter-station communications manager 1245. These components may be in electronic communication via one or more buses (e.g., bus 1250).

The communications manager 1210 may determine that a slot is configured for full duplex communications with a UE based on an uplink transmission and a downlink transmission for the UE, select an interleaving configuration for the full duplex communications in the slot based on determining that the slot is configured for full duplex communications, and communicate the uplink transmission and the downlink transmission with the UE based on the interleaving configuration.

The network communications manager 1215 may manage communications with the core network (e.g., via one or more wired backhaul links). For example, the network communications manager 1215 may manage the transfer of data communications for client devices, such as one or more UEs 115.

The transceiver 1220 may communicate bi-directionally, via one or more antennas, wired, or wireless links as described herein. For example, the transceiver 1220 may represent a wireless transceiver and may communicate bi-directionally with another wireless transceiver. The transceiver 1220 may also include a modem to modulate the packets and provide the modulated packets to the antennas for transmission, and to demodulate packets received from the antennas.

In some cases, the wireless device may include a single antenna 1225. However, in some cases the device may have more than one antenna 1225, which may be capable of concurrently transmitting or receiving multiple wireless transmissions.

The memory 1230 may include RAM, ROM, or a combination thereof. The memory 1230 may store computer-readable code 1235 including instructions that, when executed by a processor (e.g., the processor 1240) cause the device to perform various functions described herein. In some cases, the memory 1230 may contain, among other things, a BIOS which may control basic hardware or software operation such as the interaction with peripheral components or devices.

The processor 1240 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some cases, a memory controller may be integrated into processor 1240. The processor 1240 may be configured to execute computer-readable instructions stored in a memory (e.g., the memory 1230) to cause the device 1205 to perform various functions (e.g., functions or tasks supporting virtual RB to physical RB mapping in duplex slots).

The inter-station communications manager 1245 may manage communications with other base station 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communication network technology to provide communication between base stations 105.

The code 1235 may include instructions to implement aspects of the present disclosure, including instructions to support wireless communications. The code 1235 may be stored in a non-transitory computer-readable medium such as system memory or other type of memory. In some cases, the code 1235 may not be directly executable by the processor 1240 but may cause a computer (e.g., when compiled and executed) to perform functions described herein.

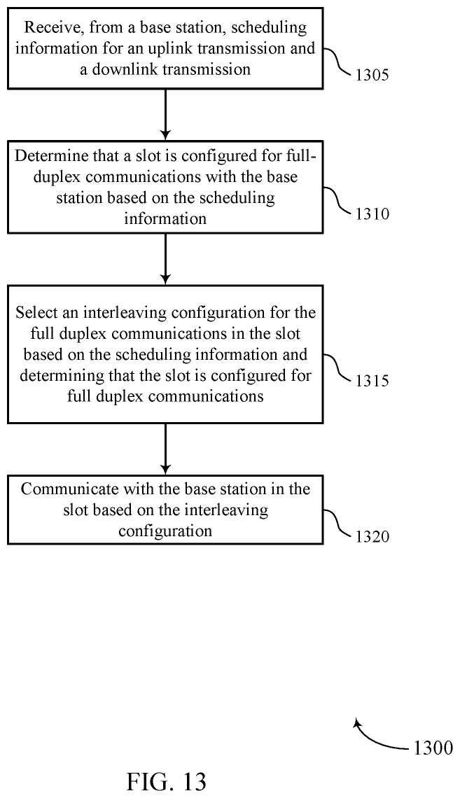

FIG. 13 shows a flowchart illustrating a method 1300 that supports virtual RB to physical RB mapping in duplex slots in accordance with aspects of the present disclosure. The operations of method 1300 may be implemented by a UE 115 or its components as described herein. For example, the operations of method 1300 may be performed by a communications manager as described with reference to FIGS. 5 through 8. In some examples, a UE may execute a set of instructions to control the functional elements of the UE to perform the functions described herein. Additionally, or alternatively, a UE may perform aspects of the functions described herein using special-purpose hardware.

At 1305, the UE may receive, from a base station, scheduling information for an uplink transmission and a downlink transmission. The operations of 1305 may be performed according to the methods described herein. In some examples, aspects of the operations of 1305 may be performed by a scheduling information receiver as described with reference to FIGS. 5 through 8.

At 1310, the UE may determine that a slot is configured for full duplex communications with the base station based on the scheduling information. The operations of 1310 may be performed according to the methods described herein. In some examples, aspects of the operations of 1310 may be performed by a slot determination component as described with reference to FIGS. 5 through 8.

At 1315, the UE may select an interleaving configuration for the full duplex communications in the slot based on the scheduling information and determining that the slot is configured for full duplex communications. The operations of 1315 may be performed according to the methods described herein. In some examples, aspects of the operations of 1315 may be performed by an interleaving manager as described with reference to FIGS. 5 through 8.

At 1320, the UE may communicate with the base station in the slot based on the interleaving configuration. The operations of 1320 may be performed according to the methods described herein. In some examples, aspects of the operations of 1320 may be performed by a communications component as described with reference to FIGS. 5 through 8.

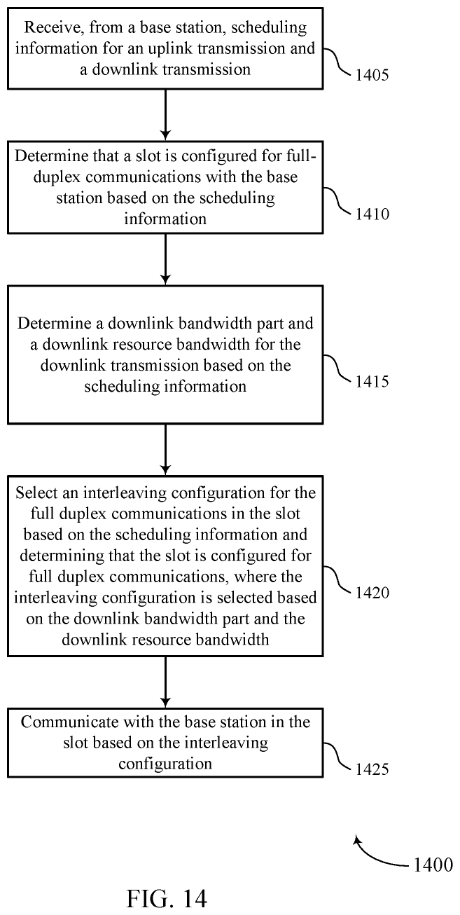

FIG. 14 shows a flowchart illustrating a method 1400 that supports virtual RB to physical RB mapping in duplex slots in accordance with aspects of the present disclosure. The operations of method 1400 may be implemented by a UE 115 or its components as described herein. For example, the operations of method 1400 may be performed by a communications manager as described with reference to FIGS. 5 through 8. In some examples, a UE may execute a set of instructions to control the functional elements of the UE to perform the functions described herein. Additionally, or alternatively, a UE may perform aspects of the functions described herein using special-purpose hardware.

At 1405, the UE may receive, from a base station, scheduling information for an uplink transmission and a downlink transmission. The operations of 1405 may be performed according to the methods described herein. In some examples, aspects of the operations of 1405 may be performed by a scheduling information receiver as described with reference to FIGS. 5 through 8.

At 1410, the UE may determine that a slot is configured for full duplex communications with the base station based on the scheduling information. The operations of 1410 may be performed according to the methods described herein. In some examples, aspects of the operations of 1410 may be performed by a slot determination component as described with reference to FIGS. 5 through 8.

At 1415, the UE may determine a downlink BWP and a downlink resource bandwidth for the downlink transmission based on the scheduling information. The operations of 1415 may be performed according to the methods described herein. In some examples, aspects of the operations of 1415 may be performed by a downlink transmission manager as described with reference to FIGS. 5 through 8.

At 1420, the UE may select an interleaving configuration for the full duplex communications in the slot based on the scheduling information and determining that the slot is configured for full duplex communications, where the interleaving configuration is selected based on the downlink BWP and the downlink resource bandwidth. The operations of 1420 may be performed according to the methods described herein. In some examples, aspects of the operations of 1420 may be performed by an interleaving manager as described with reference to FIGS. 5 through 8.

At 1425, the UE may communicate with the base station in the slot based on the interleaving configuration. The operations of 1425 may be performed according to the methods described herein. In some examples, aspects of the operations of 1425 may be performed by a communications component as described with reference to FIGS. 5 through 8.

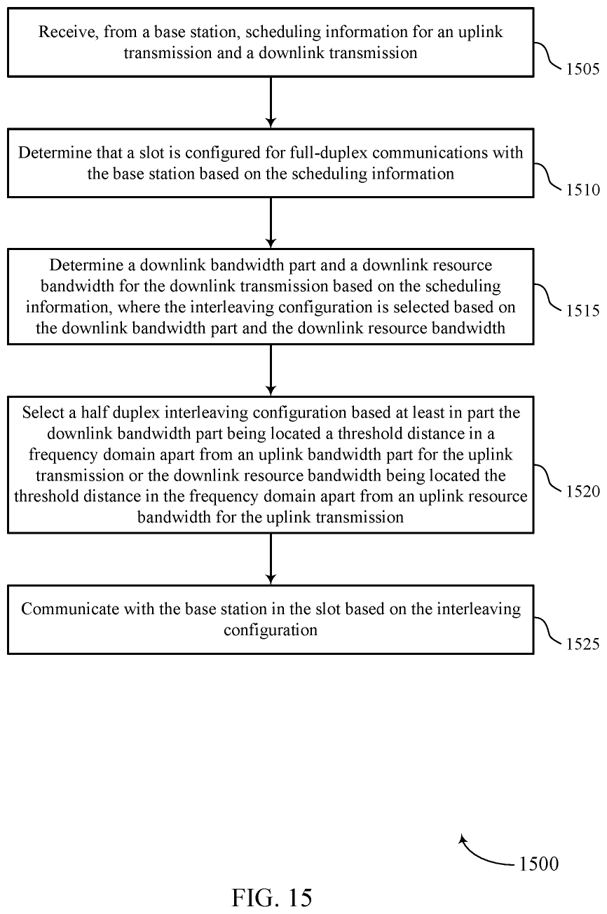

FIG. 15 shows a flowchart illustrating a method 1500 that supports virtual RB to physical RB mapping in duplex slots in accordance with aspects of the present disclosure. The operations of method 1500 may be implemented by a UE 115 or its components as described herein. For example, the operations of method 1500 may be performed by a communications manager as described with reference to FIGS. 5 through 8. In some examples, a UE may execute a set of instructions to control the functional elements of the UE to perform the functions described herein. Additionally, or alternatively, a UE may perform aspects of the functions described herein using special-purpose hardware.

At 1505, the UE may receive, from a base station, scheduling information for an uplink transmission and a downlink transmission. The operations of 1505 may be performed according to the methods described herein. In some examples, aspects of the operations of 1505 may be performed by a scheduling information receiver as described with reference to FIGS. 5 through 8.

At 1510, the UE may determine that a slot is configured for full duplex communications with the base station based on the scheduling information. The operations of 1510 may be performed according to the methods described herein. In some examples, aspects of the operations of 1510 may be performed by a slot determination component as described with reference to FIGS. 5 through 8.

At 1515, the UE may determine a downlink BWP and a downlink resource bandwidth for the downlink transmission based on the scheduling information, where the interleaving configuration is selected based on the downlink BWP and the downlink resource bandwidth. The operations of 1515 may be performed according to the methods described herein. In some examples, aspects of the operations of 1515 may be performed by a downlink transmission manager as described with reference to FIGS. 5 through 8.

At 1520, the UE may select a half duplex interleaving configuration based at least in part the downlink BWP being located a threshold distance in a frequency domain apart from an uplink BWP for the uplink transmission or the downlink resource bandwidth being located the threshold distance in the frequency domain apart from an uplink resource bandwidth for the uplink transmission. The operations of 1520 may be performed according to the methods described herein. In some examples, aspects of the operations of 1520 may be performed by a half duplex component as described with reference to FIGS. 5 through 8.

At 1525, the UE may communicate with the base station in the slot based on the interleaving configuration. The operations of 1525 may be performed according to the methods described herein. In some examples, aspects of the operations of 1525 may be performed by a communications component as described with reference to FIGS. 5 through 8.

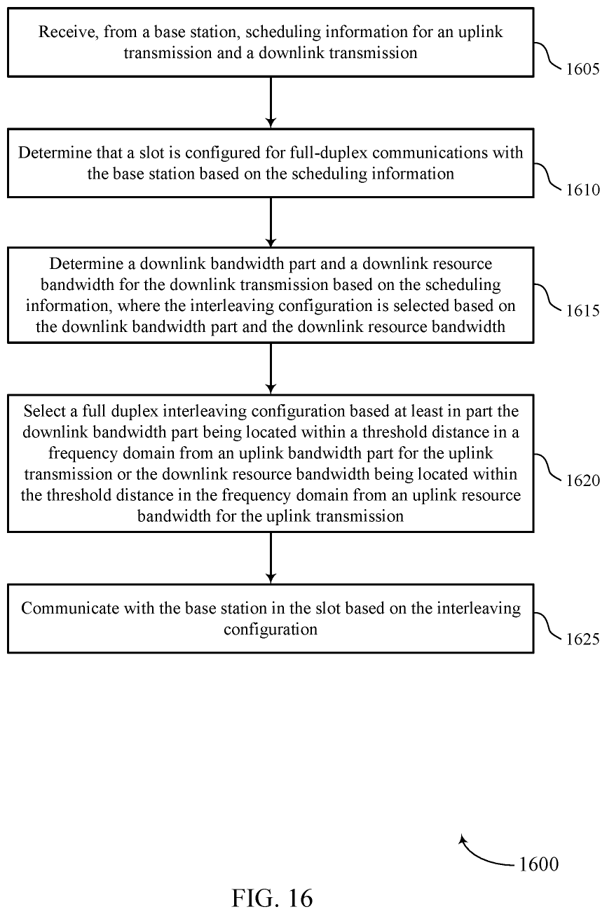

FIG. 16 shows a flowchart illustrating a method 1600 that supports virtual RB to physical RB mapping in duplex slots in accordance with aspects of the present disclosure. The operations of method 1600 may be implemented by a UE 115 or its components as described herein. For example, the operations of method 1600 may be performed by a communications manager as described with reference to FIGS. 5 through 8. In some examples, a UE may execute a set of instructions to control the functional elements of the UE to perform the functions described herein. Additionally, or alternatively, a UE may perform aspects of the functions described herein using special-purpose hardware.

At 1605, the UE may receive, from a base station, scheduling information for an uplink transmission and a downlink transmission. The operations of 1605 may be performed according to the methods described herein. In some examples, aspects of the operations of 1605 may be performed by a scheduling information receiver as described with reference to FIGS. 5 through 8.

At 1610, the UE may determine that a slot is configured for full duplex communications with the base station based on the scheduling information. The operations of 1610 may be performed according to the methods described herein. In some examples, aspects of the operations of 1610 may be performed by a slot determination component as described with reference to FIGS. 5 through 8.

At 1615, the UE may determine a downlink BWP and a downlink resource bandwidth for the downlink transmission based on the scheduling information, where the interleaving configuration is selected based on the downlink BWP and the downlink resource bandwidth. The operations of 1615 may be performed according to the methods described herein. In some examples, aspects of the operations of 1615 may be performed by a downlink transmission manager as described with reference to FIGS. 5 through 8.

At 1620, the UE may select a full duplex interleaving configuration based at least in part the downlink BWP being located within a threshold distance in a frequency domain from an uplink BWP for the uplink transmission or the downlink resource bandwidth being located within the threshold distance in the frequency domain from an uplink resource bandwidth for the uplink transmission. The operations of 1620 may be performed according to the methods described herein. In some examples, aspects of the operations of 1620 may be performed by a full duplex component as described with reference to FIGS. 5 through 8.

At 1625, the UE may communicate with the base station in the slot based on the interleaving configuration. The operations of 1625 may be performed according to the methods described herein. In some examples, aspects of the operations of 1625 may be performed by a communications component as described with reference to FIGS. 5 through 8.

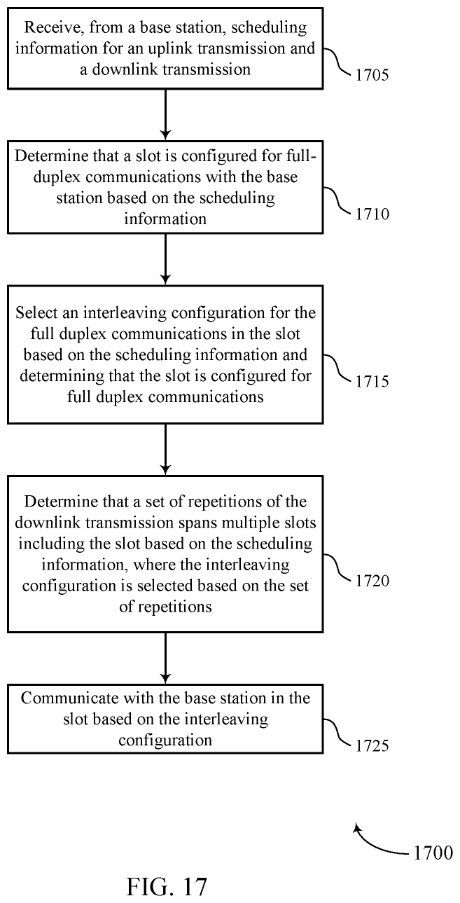

FIG. 17 shows a flowchart illustrating a method 1700 that supports virtual RB to physical RB mapping in duplex slots in accordance with aspects of the present disclosure. The operations of method 1700 may be implemented by a UE 115 or its components as described herein. For example, the operations of method 1700 may be performed by a communications manager as described with reference to FIGS. 5 through 8. In some examples, a UE may execute a set of instructions to control the functional elements of the UE to perform the functions described herein. Additionally, or alternatively, a UE may perform aspects of the functions described herein using special-purpose hardware.

At 1705, the UE may receive, from a base station, scheduling information for an uplink transmission and a downlink transmission. The operations of 1705 may be performed according to the methods described herein. In some examples, aspects of the operations of 1705 may be performed by a scheduling information receiver as described with reference to FIGS. 5 through 8.

At 1710, the UE may determine that a slot is configured for full duplex communications with the base station based on the scheduling information. The operations of 1710 may be performed according to the methods described herein. In some examples, aspects of the operations of 1710 may be performed by a slot determination component as described with reference to FIGS. 5 through 8.

At 1715, the UE may select an interleaving configuration for the full duplex communications in the slot based on the scheduling information and determining that the slot is configured for full duplex communications. The operations of 1715 may be performed according to the methods described herein. In some examples, aspects of the operations of 1715 may be performed by an interleaving manager as described with reference to FIGS. 5 through 8.

At 1720, the UE may determine that a set of repetitions of the downlink transmission spans multiple slots including the slot based on the scheduling information, where the interleaving configuration is selected based on the set of repetitions. The operations of 1720 may be performed according to the methods described herein. In some examples, aspects of the operations of 1720 may be performed by a repetition manager as described with reference to FIGS. 5 through 8.

At 1725, the UE may communicate with the base station in the slot based on the interleaving configuration. The operations of 1725 may be performed according to the methods described herein. In some examples, aspects of the operations of 1725 may be performed by a communications component as described with reference to FIGS. 5 through 8.

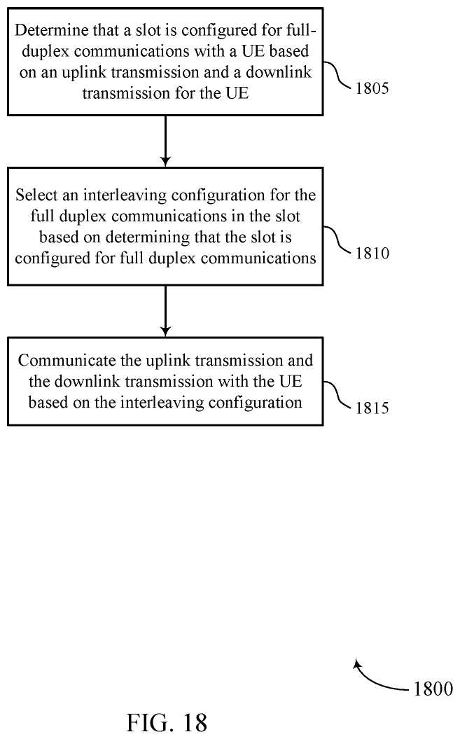

FIG. 18 shows a flowchart illustrating a method 1800 that supports virtual RB to physical RB mapping in duplex slots in accordance with aspects of the present disclosure. The operations of method 1800 may be implemented by a base station 105 or its components as described herein. For example, the operations of method 1800 may be performed by a communications manager as described with reference to FIGS. 9 through 12. In some examples, a base station may execute a set of instructions to control the functional elements of the base station to perform the functions described herein. Additionally, or alternatively, a base station may perform aspects of the functions described herein using special-purpose hardware.

At 1805, the base station may determine that a slot is configured for full duplex communications with a UE based on an uplink transmission and a downlink transmission for the UE. The operations of 1805 may be performed according to the methods described herein. In some examples, aspects of the operations of 1805 may be performed by a slot manager as described with reference to FIGS. 9 through 12.

At 1810, the base station may select an interleaving configuration for the full duplex communications in the slot based on determining that the slot is configured for full duplex communications. The operations of 1810 may be performed according to the methods described herein. In some examples, aspects of the operations of 1810 may be performed by a selection component as described with reference to FIGS. 9 through 12.

At 1815, the base station may communicate the uplink transmission and the downlink transmission with the UE based on the interleaving configuration. The operations of 1815 may be performed according to the methods described herein. In some examples, aspects of the operations of 1815 may be performed by a communications component as described with reference to FIGS. 9 through 12.

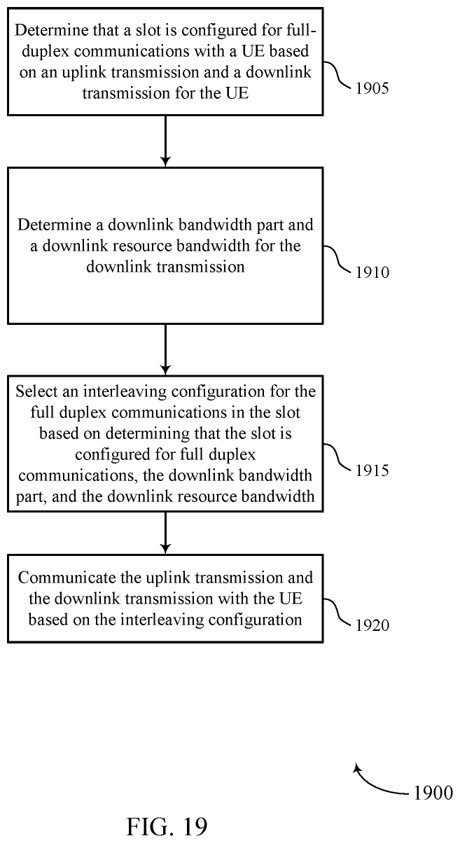

FIG. 19 shows a flowchart illustrating a method 1900 that supports virtual RB to physical RB mapping in duplex slots in accordance with aspects of the present disclosure. The operations of method 1900 may be implemented by a base station 105 or its components as described herein. For example, the operations of method 1900 may be performed by a communications manager as described with reference to FIGS. 9 through 12. In some examples, a base station may execute a set of instructions to control the functional elements of the base station to perform the functions described herein. Additionally, or alternatively, a base station may perform aspects of the functions described herein using special-purpose hardware.

At 1905, the base station may determine that a slot is configured for full duplex communications with a UE based on an uplink transmission and a downlink transmission for the UE. The operations of 1905 may be performed according to the methods described herein. In some examples, aspects of the operations of 1905 may be performed by a slot manager as described with reference to FIGS. 9 through 12.

At 1910, the base station may determine a downlink BWP and a downlink resource bandwidth for the downlink transmission, where the interleaving configuration is selected based on the downlink BWP and the downlink resource bandwidth. The operations of 1910 may be performed according to the methods described herein. In some examples, aspects of the operations of 1910 may be performed by a downlink manager as described with reference to FIGS. 9 through 12.

At 1915, the base station may select an interleaving configuration for the full duplex communications in the slot based on determining that the slot is configured for full duplex communications, the downlink BWP, and the downlink resource bandwidth. The operations of 1915 may be performed according to the methods described herein. In some examples, aspects of the operations of 1915 may be performed by a selection component as described with reference to FIGS. 9 through 12.

At 1920, the base station may communicate the uplink transmission and the downlink transmission with the UE based on the interleaving configuration. The operations of 1920 may be performed according to the methods described herein. In some examples, aspects of the operations of 1920 may be performed by a communications component as described with reference to FIGS. 9 through 12.

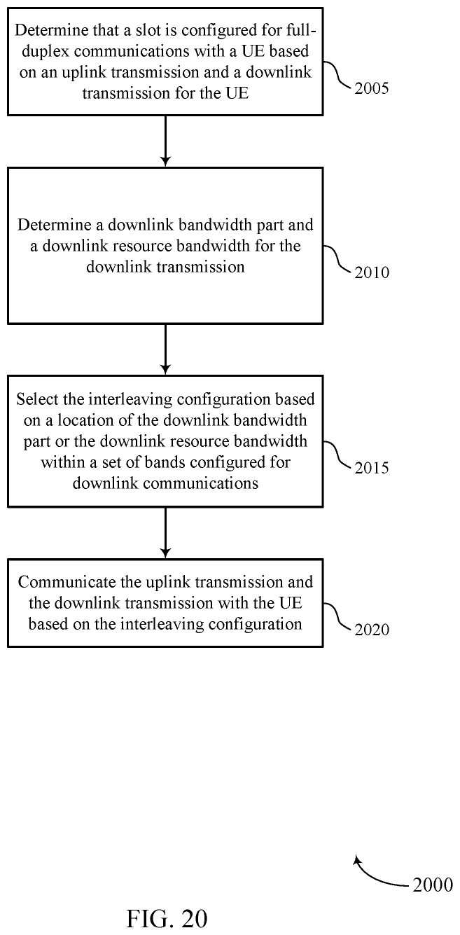

FIG. 20 shows a flowchart illustrating a method 2000 that supports virtual RB to physical RB mapping in duplex slots in accordance with aspects of the present disclosure. The operations of method 2000 may be implemented by a base station 105 or its components as described herein. For example, the operations of method 2000 may be performed by a communications manager as described with reference to FIGS. 9 through 12. In some examples, a base station may execute a set of instructions to control the functional elements of the base station to perform the functions described herein. Additionally, or alternatively, a base station may perform aspects of the functions described herein using special-purpose hardware.

At 2005, the base station may determine that a slot is configured for full duplex communications with a UE based on an uplink transmission and a downlink transmission for the UE. The operations of 2005 may be performed according to the methods described herein. In some examples, aspects of the operations of 2005 may be performed by a slot manager as described with reference to FIGS. 9 through 12.

At 2010, the base station may determine a downlink BWP and a downlink resource bandwidth for the downlink transmission. The operations of 2010 may be performed according to the methods described herein. In some examples, aspects of the operations of 2010 may be performed by a downlink manager as described with reference to FIGS. 9 through 12.

At 2015, the base station may select the interleaving configuration based on a location of the downlink BWP or the downlink resource bandwidth within a set of bands configured for downlink communications. The operations of 2015 may be performed according to the methods described herein. In some examples, aspects of the operations of 2015 may be performed by a selection component as described with reference to FIGS. 9 through 12.

At 2020, the base station may communicate the uplink transmission and the downlink transmission with the UE based on the interleaving configuration. The operations of 2020 may be performed according to the methods described herein. In some examples, aspects of the operations of 2020 may be performed by a communications component as described with reference to FIGS. 9 through 12.

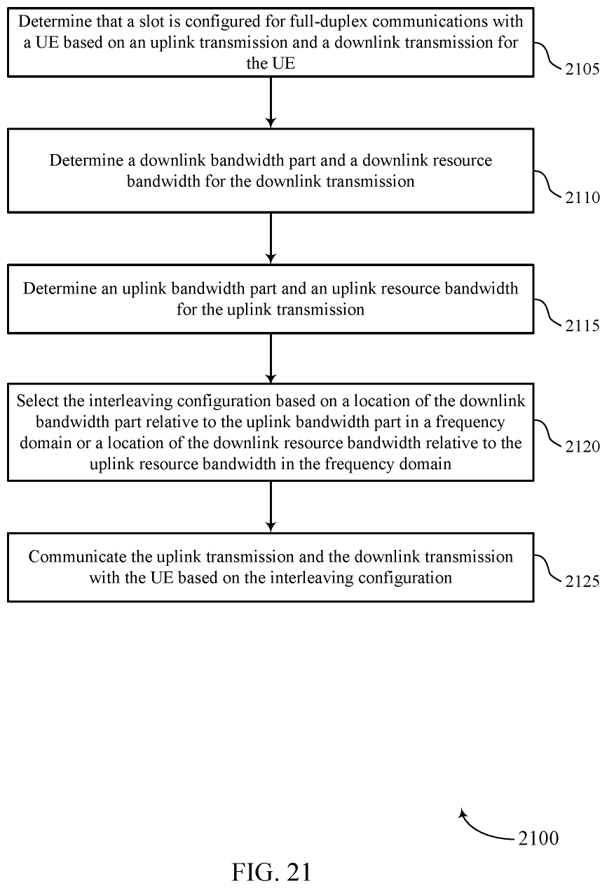

FIG. 21 shows a flowchart illustrating a method 2100 that supports virtual RB to physical RB mapping in duplex slots in accordance with aspects of the present disclosure. The operations of method 2100 may be implemented by a base station 105 or its components as described herein. For example, the operations of method 2100 may be performed by a communications manager as described with reference to FIGS. 9 through 12. In some examples, a base station may execute a set of instructions to control the functional elements of the base station to perform the functions described herein. Additionally, or alternatively, a base station may perform aspects of the functions described herein using special-purpose hardware.

At 2105, the base station may determine that a slot is configured for full duplex communications with a UE based on an uplink transmission and a downlink transmission for the UE. The operations of 2105 may be performed according to the methods described herein. In some examples, aspects of the operations of 2105 may be performed by a slot manager as described with reference to FIGS. 9 through 12.

At 2110, the base station may determine a downlink BWP and a downlink resource bandwidth for the downlink transmission. The operations of 2110 may be performed according to the methods described herein. In some examples, aspects of the operations of 2110 may be performed by a downlink manager as described with reference to FIGS. 9 through 12.

At 2115, the base station may determine an uplink BWP and an uplink resource bandwidth for the uplink transmission. The operations of 2115 may be performed according to the methods described herein. In some examples, aspects of the operations of 2115 may be performed by an uplink manager as described with reference to FIGS. 9 through 12.

At 2120, the base station may select the interleaving configuration based on a location of the downlink BWP relative to the uplink BWP in a frequency domain or a location of the downlink resource bandwidth relative to the uplink resource bandwidth in the frequency domain. The operations of 2120 may be performed according to the methods described herein. In some examples, aspects of the operations of 2120 may be performed by a selection component as described with reference to FIGS. 9 through 12.

At 2125, the base station may communicate the uplink transmission and the downlink transmission with the UE based on the interleaving configuration. The operations of 2125 may be performed according to the methods described herein. In some examples, aspects of the operations of 2125 may be performed by a communications component as described with reference to FIGS. 9 through 12.

It should be noted that the methods described herein describe possible implementations, and that the operations and the steps may be rearranged or otherwise modified and that other implementations are possible. Further, aspects from two or more of the methods may be combined.

The following provides an overview of aspects of the present disclosure:

Aspect 1: A method for wireless communication at a UE, comprising: receiving, from a base station, scheduling information for an uplink transmission and a downlink transmission; determining that a slot is configured for full duplex communications with the base station based at least in part on the scheduling information; selecting an interleaving configuration for the full duplex communications in the slot based at least in part on the scheduling information and determining that the slot is configured for full duplex communications; and communicating with the base station in the slot based at least in part on the interleaving configuration.

Aspect 2: The method of aspect 1, further comprising: determining a downlink bandwidth part and a downlink resource bandwidth for the downlink transmission based at least in part on the scheduling information, wherein the interleaving configuration is selected based at least in part on the downlink bandwidth part and the downlink resource bandwidth.

Aspect 3: The method of aspect 2, wherein selecting the interleaving configuration comprises: selecting the interleaving configuration based at least in part on a location of the downlink bandwidth part and the downlink resource bandwidth within a set of bands configured for downlink communications.

Aspect 4: The method of any of aspects 2 through 3, wherein selecting the interleaving configuration comprises: determining an uplink bandwidth part and an uplink resource bandwidth for the uplink transmission based at least in part on the scheduling information; and selecting the interleaving configuration based at least in part on a location of the downlink bandwidth part relative to the uplink bandwidth part in a frequency domain or a location of the downlink resource bandwidth relative to the uplink resource bandwidth in the frequency domain.

Aspect 5: The method of any of aspects 2 through 4, wherein selecting the interleaving configuration comprises: selecting a half duplex interleaving configuration based at least in part on the downlink bandwidth part being located a threshold distance in a frequency domain apart from an uplink bandwidth part for the uplink transmission or the downlink resource bandwidth being located the threshold distance in the frequency domain apart from an uplink resource bandwidth for the uplink transmission.

Aspect 6: The method of any of aspects 2 through 4, wherein selecting the interleaving configuration comprises: selecting a full duplex interleaving configuration based at least in part on the downlink bandwidth part being located within a threshold distance in a frequency domain from an uplink bandwidth part for the uplink transmission or the downlink resource bandwidth being located within the threshold distance in the frequency domain from an uplink resource bandwidth for the uplink transmission.

Aspect 7: The method of any of aspects 2 through 4, further comprising: determining multiple downlink bandwidth parts for the downlink transmission based at least in part on the scheduling information; and selecting the interleaving configuration based at least in part on respective locations of the multiple downlink bandwidth parts within a set of bands configured for downlink communications.

Aspect 8: The method of aspect 7, wherein selecting the interleaving configuration comprises: selecting a full duplex interleaving configuration based at least in part on the respective locations being positioned on both sides of an uplink bandwidth part for the uplink transmission in a frequency domain.

Aspect 9: The method of any of aspects 1 through 8, wherein selecting the interleaving configuration comprises: selecting a full duplex interleaving configuration based at least in part on determining that the slot is configured for full duplex communications.

Aspect 10: The method of any of aspects 1 through 9, wherein receiving the scheduling information comprises: receiving an indication of the interleaving configuration, wherein selecting the interleaving configuration is based at least in part on the indication and the indication is a one bit indicator within downlink control information.

Aspect 11: The method of any of aspects 1 through 10, further comprising: determining that a set of repetitions of the downlink transmission spans multiple slots including the slot based at least in part on the scheduling information, wherein the interleaving configuration is selected based at least in part on the set of repetitions.

Aspect 12: The method of aspect 11, wherein selecting the interleaving configuration comprises: selecting a half duplex interleaving configuration for each slot of the multiple slots configured for half duplex communications; and selecting a full duplex interleaving configuration for each slot of the multiple slots configured for full duplex communications.

Aspect 13: The method of aspect 11, further comprising: determining a downlink bandwidth part and a downlink resource bandwidth for a repetition of the set of repetitions in a full duplex slot of the multiple slots; and selecting a half duplex interleaving configuration for the full duplex slot based at least in part on the downlink bandwidth part being located a threshold distance in a frequency domain apart from an uplink bandwidth part for the uplink transmission or the downlink resource bandwidth being located the threshold distance in the frequency domain apart from an uplink resource bandwidth for the uplink transmission.

Aspect 14: The method of aspect 13, further comprising: receiving a message indicating the half duplex interleaving configuration from the base station, wherein the half duplex interleaving configuration is selected based at least in part on the message.

Aspect 15: The method of aspect 11, further comprising: determining multiple downlink bandwidth parts for a repetition of the set of repetitions in a full duplex slot of the multiple slots; and selecting a full duplex interleaving configuration for the full duplex slot based at least in part on the multiple downlink bandwidth parts being positioned on both sides of an uplink bandwidth part for the uplink transmission in a frequency domain within the full duplex slot.

Aspect 16: A method for wireless communications at a base station, comprising: determining that a slot is configured for full duplex communications with a UE based at least in part on an uplink transmission and a downlink transmission for the UE; selecting an interleaving configuration for the full duplex communications in the slot based at least in part on determining that the slot is configured for full duplex communications; and communicating the uplink transmission and the downlink transmission with the UE based at least in part on the interleaving configuration.

Aspect 17: The method of aspect 16, further comprising: determining a downlink bandwidth part and a downlink resource bandwidth for the downlink transmission, wherein the interleaving configuration is selected based at least in part on the downlink bandwidth part and the downlink resource bandwidth.

Aspect 18: The method of aspect 17, wherein selecting the interleaving configuration comprises: selecting the interleaving configuration based at least in part on a location of the downlink bandwidth part or the downlink resource bandwidth within a set of bands configured for downlink communications.

Aspect 19: The method of any of aspects 17 through 18, wherein selecting the interleaving configuration comprises: determining an uplink bandwidth part and an uplink resource bandwidth for the uplink transmission; and selecting the interleaving configuration based at least in part on a location of the downlink bandwidth part relative to the uplink bandwidth part in a frequency domain or a location of the downlink resource bandwidth relative to the uplink resource bandwidth in the frequency domain.

Aspect 20: The method of any of aspects 17 through 19, wherein selecting the interleaving configuration comprises: selecting a half duplex interleaving configuration based at least in part on the downlink bandwidth part being located a threshold distance in a frequency domain apart from an uplink bandwidth part for the uplink transmission or the downlink resource bandwidth being located the threshold distance in the frequency domain apart from an uplink resource bandwidth for the uplink transmission.

Aspect 21: The method of any of aspects 17 through 19, further comprising: determining multiple downlink bandwidth parts for the downlink transmission; and selecting the interleaving configuration based at least in part on respective locations of the multiple downlink bandwidth parts within a set of bands configured for downlink communications.

Aspect 22: The method of aspect 21, wherein selecting the interleaving configuration comprises: selecting a full duplex interleaving configuration based at least in part on the respective locations being positioned on both sides of an uplink bandwidth part for the uplink transmission in a frequency domain.

Aspect 23: The method of any of aspects 16 through 19, further comprising: selecting a full duplex interleaving configuration based at least in part on determining that the slot is configured for full duplex communications.

Aspect 24: The method of any of aspects 16 through 23, further comprising: transmitting, to the UE, scheduling information for the uplink transmission and the downlink transmission, wherein the scheduling information comprises a one bit indicator within downlink control information that indicates the interleaving configuration.

Aspect 25: The method of any of aspects 16 through 24, further comprising: determining that a set of repetitions of the downlink transmission spans multiple slots including the slot, wherein the interleaving configuration is selected based at least in part on the set of repetitions.

Aspect 26: The method of aspect 25, wherein selecting the interleaving configuration comprises: selecting a half duplex interleaving configuration for each slot of the multiple slots configured for half duplex communications; and selecting a full duplex interleaving configuration for each slot of the multiple slots configured for full duplex communications.

Aspect 27: The method of aspect 25, further comprising: determining a downlink bandwidth part and a downlink resource bandwidth for a repetition of the set of repetitions in a full duplex slot of the multiple slots; and selecting a half duplex interleaving configuration for the full duplex slot based at least in part on the downlink bandwidth part being located a threshold distance in a frequency domain apart from an uplink bandwidth part for the uplink transmission or the downlink resource bandwidth being located the threshold distance in the frequency domain apart from an uplink resource bandwidth for the uplink transmission.

Aspect 28: The method of aspect 25, further comprising: determining multiple downlink bandwidth parts for a repetition of the set of repetitions in a full duplex slot of the multiple slots; and selecting a full duplex interleaving configuration for the full duplex slot based at least in part on the multiple downlink bandwidth parts being positioned on both sides of an uplink bandwidth part for the uplink transmission in a frequency domain within the full duplex slot.

Aspect 29: An apparatus for wireless communication at a UE, comprising a processor; memory coupled with the processor; and instructions stored in the memory and executable by the processor to cause the apparatus to perform a method of any of aspects 1 through 15.

Aspect 30: An apparatus for wireless communication at a UE, comprising at least one means for performing a method of any of aspects 1 through 15.

Aspect 31: A non-transitory computer-readable medium storing code for wireless communication at a UE, the code comprising instructions executable by a processor to perform a method of any of aspects 1 through 15.

Aspect 32: An apparatus for wireless communications at a base station, comprising a processor; memory coupled with the processor; and instructions stored in the memory and executable by the processor to cause the apparatus to perform a method of any of aspects 16 through 28.

Aspect 33: An apparatus for wireless communications at a base station, comprising at least one means for performing a method of any of aspects 16 through 28.

Aspect 34: A non-transitory computer-readable medium storing code for wireless communications at a base station, the code comprising instructions executable by a processor to perform a method of any of aspects 16 through 28.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication at a user equipment (UE), comprising:
receiving, from a base station, scheduling information for an uplink transmission and a downlink transmission;
determining that a slot is configured for full duplex communications with the base station based at least in part on the scheduling information;
selecting an interleaving configuration for the full duplex communications in the slot based at least in part on the scheduling information and determining that the slot is configured for full duplex communications; and
communicating with the base station in the slot based at least in part on the interleaving configuration.

2. The method of claim 1, further comprising:
determining a downlink bandwidth part and a downlink resource bandwidth for the downlink transmission based at least in part on the scheduling information, wherein the interleaving configuration is selected based at least in part on the downlink bandwidth part and the downlink resource bandwidth.

3. The method of claim 2, wherein selecting the interleaving configuration comprises:
selecting the interleaving configuration based at least in part on a location of the downlink bandwidth part and the downlink resource bandwidth within a set of bands configured for downlink communications.

4. The method of claim 2, wherein selecting the interleaving configuration comprises:
determining an uplink bandwidth part and an uplink resource bandwidth for the uplink transmission based at least in part on the scheduling information; and
selecting the interleaving configuration based at least in part on a location of the downlink bandwidth part relative to the uplink bandwidth part in a frequency domain or a location of the downlink resource bandwidth relative to the uplink resource bandwidth in the frequency domain.

5. The method of claim 2, wherein selecting the interleaving configuration comprises:
selecting a half duplex interleaving configuration based at least in part on the downlink bandwidth part being located a threshold distance in a frequency domain apart from an uplink bandwidth part for the uplink transmission or the downlink resource bandwidth being located the threshold distance in the frequency domain apart from an uplink resource bandwidth for the uplink transmission.

6. The method of claim 2, wherein selecting the interleaving configuration comprises:
selecting a full duplex interleaving configuration based at least in part on the downlink bandwidth part being located within a threshold distance in a frequency domain from an uplink bandwidth part for the uplink transmission or the downlink resource bandwidth being located within the threshold distance in the frequency domain from an uplink resource bandwidth for the uplink transmission.

7. The method of claim 2, further comprising:
determining multiple downlink bandwidth parts for the downlink transmission based at least in part on the scheduling information; and
selecting the interleaving configuration based at least in part on respective locations of the multiple downlink bandwidth parts within a set of bands configured for downlink communications.

8. The method of claim 7, wherein selecting the interleaving configuration comprises:
selecting a full duplex interleaving configuration based at least in part on the respective locations being positioned on both sides of an uplink bandwidth part for the uplink transmission in a frequency domain.

9. The method of claim 1, wherein selecting the interleaving configuration comprises:
selecting a full duplex interleaving configuration based at least in part on determining that the slot is configured for full duplex communications.

10. The method of claim 1, wherein receiving the scheduling information comprises:
receiving an indication of the interleaving configuration, wherein selecting the interleaving configuration is based at least in part on the indication and the indication is a one bit indicator within downlink control information.

11. The method of claim 1, further comprising:
determining that a set of repetitions of the downlink transmission spans multiple slots including the slot based at least in part on the scheduling information, wherein the interleaving configuration is selected based at least in part on the set of repetitions.

12. The method of claim 11, wherein selecting the interleaving configuration comprises:
selecting a half duplex interleaving configuration for each slot of the multiple slots configured for half duplex communications; and
selecting a full duplex interleaving configuration for each slot of the multiple slots configured for full duplex communications.

13. The method of claim 11, further comprising:
determining a downlink bandwidth part and a downlink resource bandwidth for a repetition of the set of repetitions in a full duplex slot of the multiple slots; and
selecting a half duplex interleaving configuration for the full duplex slot based at least in part on the downlink bandwidth part being located a threshold distance in a frequency domain apart from an uplink bandwidth part for the uplink transmission or the downlink resource bandwidth being located the threshold distance in the frequency domain apart from an uplink resource bandwidth for the uplink transmission.

14. The method of claim 13, further comprising:
receiving a message indicating the half duplex interleaving configuration from the base station, wherein the half duplex interleaving configuration is selected based at least in part on the message.

15. The method of claim 11, further comprising:
determining multiple downlink bandwidth parts for a repetition of the set of repetitions in a full duplex slot of the multiple slots; and
selecting a full duplex interleaving configuration for the full duplex slot based at least in part on the multiple downlink bandwidth parts being positioned on both sides of an uplink bandwidth part for the uplink transmission in a frequency domain within the full duplex slot.

16. A method for wireless communications at a base station, comprising:
determining that a slot is configured for full duplex communications with a user equipment (UE) based at least in part on an uplink transmission and a downlink transmission for the UE;
selecting an interleaving configuration for the full duplex communications in the slot based at least in part on determining that the slot is configured for full duplex communications; and
communicating the uplink transmission and the downlink transmission with the UE based at least in part on the interleaving configuration.

17. The method of claim 16, further comprising:
determining a downlink bandwidth part and a downlink resource bandwidth for the downlink transmission, wherein the interleaving configuration is selected based at least in part on the downlink bandwidth part and the downlink resource bandwidth.

18. The method of claim 17, wherein selecting the interleaving configuration comprises:
selecting the interleaving configuration based at least in part on a location of the downlink bandwidth part or the downlink resource bandwidth within a set of bands configured for downlink communications.

19. The method of claim 17, wherein selecting the interleaving configuration comprises:
determining an uplink bandwidth part and an uplink resource bandwidth for the uplink transmission; and
selecting the interleaving configuration based at least in part on a location of the downlink bandwidth part relative to the uplink bandwidth part in a frequency domain or a location of the downlink resource bandwidth relative to the uplink resource bandwidth in the frequency domain.

20. The method of claim 17, wherein selecting the interleaving configuration comprises:
selecting a half duplex interleaving configuration based at least in part on the downlink bandwidth part being located a threshold distance in a frequency domain apart from an uplink bandwidth part for the uplink transmission or the downlink resource bandwidth being located the threshold distance in the frequency domain apart from an uplink resource bandwidth for the uplink transmission.

21. The method of claim 17, further comprising:
determining multiple downlink bandwidth parts for the downlink transmission; and
selecting the interleaving configuration based at least in part on respective locations of the multiple downlink bandwidth parts within a set of bands configured for downlink communications.

22. The method of claim 21, wherein selecting the interleaving configuration comprises:
selecting a full duplex interleaving configuration based at least in part on the respective locations being positioned on both sides of an uplink bandwidth part for the uplink transmission in a frequency domain.

23. The method of claim 16, further comprising:
selecting a full duplex interleaving configuration based at least in part on determining that the slot is configured for full duplex communications.

24. The method of claim 16, further comprising:
transmitting, to the UE, scheduling information for the uplink transmission and the downlink transmission, wherein the scheduling information comprises a one bit indicator within downlink control information that indicates the interleaving configuration.

25. The method of claim 16, further comprising:
determining that a set of repetitions of the downlink transmission spans multiple slots including the slot, wherein the interleaving configuration is selected based at least in part on the set of repetitions.

26. The method of claim 25, wherein selecting the interleaving configuration comprises:
selecting a half duplex interleaving configuration for each slot of the multiple slots configured for half duplex communications; and
selecting a full duplex interleaving configuration for each slot of the multiple slots configured for full duplex communications.

27. The method of claim 25, further comprising:
determining a downlink bandwidth part and a downlink resource bandwidth for a repetition of the set of repetitions in a full duplex slot of the multiple slots; and
selecting a half duplex interleaving configuration for the full duplex slot based at least in part on the downlink bandwidth part being located a threshold distance in a frequency domain apart from an uplink bandwidth part for the uplink transmission or the downlink resource bandwidth being located the threshold distance in the frequency domain apart from an uplink resource bandwidth for the uplink transmission.

28. The method of claim 25, further comprising:
determining multiple downlink bandwidth parts for a repetition of the set of repetitions in a full duplex slot of the multiple slots; and
selecting a full duplex interleaving configuration for the full duplex slot based at least in part on the multiple downlink bandwidth parts being positioned on both sides of an uplink bandwidth part for the uplink transmission in a frequency domain within the full duplex slot.

29. An apparatus for wireless communication at a user equipment (UE), comprising:
a processor,
memory coupled with the processor; and
instructions stored in the memory and executable by the processor to cause the apparatus to:
receive, from a base station, scheduling information for an uplink transmission and a downlink transmission;
determine that a slot is configured for full duplex communications with the base station based at least in part on the scheduling information;
select an interleaving configuration for the full duplex communications in the slot based at least in part on the scheduling information and determining that the slot is configured for full duplex communications; and
communicate with the base station in the slot based at least in part on the interleaving configuration.

30. An apparatus for wireless communications at a base station, comprising:
a processor,
memory coupled with the processor; and
instructions stored in the memory and executable by the processor to cause the apparatus to:
determine that a slot is configured for full duplex communications with a user equipment (UE) based at least in part on an uplink transmission and a downlink transmission for the UE;
select an interleaving configuration for the full duplex communications in the slot based at least in part on determining that the slot is configured for full duplex communications; and
communicate the uplink transmission and the downlink transmission with the UE based at least in part on the interleaving configuration.
